(19) United States
(12) Patent Application Publication
(10) Pub. No.: US 2026/0269481 A1
(43) Pub. Date: Sep. 10, 2026

(54) Transportable Rapidly Deployable High-Frequency (HF) Horizontal Fan Antenna System and Method

(71) Applicant: SABRE SYSTEMS, INC., Warminster, PA (US)

(72) Inventors: James K Breakall, Port Matilda, PA (US); Karl Hosterman, Julian, PA (US); Jack Burbank, Hanover, PA (US); Kade Poorman, Milroy, PA (US)

(73) Assignee: SABRE SYSTEMS, INC, Warminster, PA (US)

(21) Appl. No.: 19/555,411

(22) Filed: Mar. 3, 2026

Related U.S. Application Data
(60) Provisional application No. 63/766,036, filed on Mar. 3, 2025.
(60) Provisional application No. 63/894,268, filed on Oct. 6, 2025.

(51) Int. Cl. H01Q 9/12; H01Q 1/10

(52) U.S. Cl. CPC H01Q 9/12; H01Q 1/10

(57) ABSTRACT

A transportable rapidly deployable High-Frequency (HF) horizontal fan antenna system 100 adapted for NVIS or long skip HF propagation comprises a transportable HF dipole antenna assembly 300 including a sloped dipole pair of first fan antenna assembly 300A and second fan antenna assembly 300B which are radially arrayed at substantially 180 degrees from one another while fitting within a short horizontal distance (e.g., less than 52 feet) between the opposing bottom or distal ands of the fan assemblies. Surprisingly, the transportable HF dipole antenna system of the present invention provides good VSWR impedance match over a frequency range of 8 MHz to 30 MHz while providing a horizontal fan radiation pattern that varies in the range of 0 db to −5 dB for HF frequencies in the range of 3 MHz to 15 MHz, so expeditionary users can set up antenna system 100 quickly and are more likely to immediately receive signals from nearly any azimuth without undue dipole element setup or aiming trial and error.

### CROSS-REFERENCE TO RELATED APPLICATIONS AND PRIORITY CLAIMS

This US Utility patent application claims priority to (a) related, commonly owned U.S. provisional patent application no. 63/766036, entitled Transportable Rapidly Deployable High-Frequency (HF) Horizontal Fan Antenna System and Method (filed 3 Mar., 2025) and (b) related, commonly owned U.S. provisional patent application no. 63/894,268, entitled eXpeditionary High-Frequency (X_{HF}) Enhanced NVIS 2- wire (ENV-2) Antenna System and Method (filed 6 Oct. 2025), the entire disclosures of which is incorporated herein by reference. This application is also broadly related to applicant's commonly owned U.S. provisional patent application no. 63/766170 entitled Transportable Rapidly Deployable High-Frequency (HF) Vertical Diamond Antenna System and Method, filed 3 Mar. 2025, the entire disclosure of which is also incorporated herein by reference for background, enablement and nomenclature purposes.

### BACKGROUND

### 1. Field

One or more embodiments of the present invention relate to High Frequency (“HF”) band antenna and coupling systems for use in transportable wireless communication systems. products, other articles and combinations, and methods and processes for configuring, transporting, erecting and employing High Frequency (“HF”) band antenna and coupling systems.

### 2. Discussion of the Related Art

Wireless (e.g., Radio) communication systems are traditionally configured to serve a variety of communication needs and are often licensed to transmit and receive in selected radio frequency bands. High Frequency (“HF”) systems operate across the 3-30 MHz (HF) frequency band in a variety of applications using specially configured HF antennas which include application specific compromises that balance practical operating considerations such as available space, required distance between transmitters and receivers, transmitter power, as well as antenna gain, radiation patterns, and Voltage Standing Wave Ratio (“VSWR”) (an impedance matching dimension also referred to in this application as SWR). HF antennas are used in military and civilian applications including Amateur (or “Ham”) Radio communications. Military users have rigorous requirements for portability, especially when engaged in expeditionary operations.

Traditional HF antennas for many applications (see, e.g., FIGS. 1A-1G) are very large, requiring a significant amount of real estate and infrastructure to establish. Furthermore, traditional HF antennas are complex to set up or erect, requiring a large team of relatively skilled operators a significant amount of time. Horizontal HF antennas often are hundreds of feet in length, while vertical HF antennas can be hundreds of feet tall and require a commercial grade tower to host. HF antennas often have localized performance notches over certain frequency bands at specified elevation takeoff angles, where performance for a portion of the HF band is significantly less than other portions of the band (in terms of reduced gain and/or increased VSWR). Many HF antennas perform poorly unless an external adjustable RF interface network or “tuner” is inserted in the signal path between the radio (e.g., transceiver) and the antenna to allow an operator to optimize or match the antenna's impedance to the radio for a particular use case. Many existing HF antennas are extremely narrowband in nature, restricting the simultaneous use to a very small portion of the HF frequency band, often as small as 2 kHz, which limits the utility of traditional HF radios for certain waveforms.

One application for HF radios is the Near Vertical Incidence Skywave (NVIS) communications. NVIS systems (see, e.g., FIGS. 1A-1F), employ an ionospheric skip operating technique that directs the strongest signals from a station vertically, or upward, rather than toward the horizon (as illustrated in FIG. 1A). Signals propagating nearly vertically (e.g., 2) approach the ionosphere with steep incidence angles and may be bent back to earth with similarly small angles (e.g., 4). The operational result is skip communications effective within a radius of a few hundred miles. The NVIS technique can help to bridge the communications gap between the local communications and the longer distance skip propagation (e.g., 6) of low-to-the-horizon HF signals. The NVIS technique relies upon a combination of station factors, most importantly the frequency used, the power of transmissions, and the antenna configuration. Referring to FIG. 1B, a horizontally polarized antenna provides the best NVIS propagation. A wire half-wave dipole (see e.g., FIG. 1B configuration 10 or 12) trimmed for the frequency of use is the most common type of antenna used for NVIS. In the half-wave dipole case, a flattop configuration 10 or mildly down-sloped inverted V configuration 12 can work, if properly spaced and supported at a particular height above ground.

Referring next to the Diagrams of FIGS. 1C-1F, the military uses a dual band NVIS antenna 16 known as the AS-2259/GR which includes a pair collapsible of crossed inverted V dipoles supported at the center by a sectioned fifteen foot tall mast. The dipoles (shown in perspective in FIG. 1C and from a top view in FIG. 1D) are affixed by guy wires to the earth (as seen from orthogonal side views in FIGS. 1E and 1F) and the antenna is tuned for NVIS use, but only over a limited bandwidth (e.g., from 2 MHz to 10MHz). The dedicated NVIS antenna of FIGS. 1C-1F is useful for dedicated relatively short range communication, aiming its energy straight up, as illustrated in FIG. 1A, but it's substantially less effective at longer communication distances (greater than 300 miles) which require a more nearly horizontal radiation pattern (e.g., 6 in FIG. 1A). The radiating portions of dipole antenna AS-2259/GR, as seen in FIGS. 1E and 1F are over 11 meters (38 feet) in length on one side and over 7 meters (25 feet) in length from the orthogonal direction, and the antenna, with staked out insulated cords occupies a circle of almost 26 meters (86 feet) in diameter, so the form factor of this military antenna system is somewhat cumbersome and large.

HF antennae are often used for longer distance communications, requiring a much larger antenna such as that illustrated in FIG. 1G, a diagram illustrating a dipole “G5RV” antenna 20 with a symmetric resonant feeder line, which serves as a coupler 26 or impedance matcher for a 50 Ω coax cable to a radio transceiver 30. Louis Varney (G 5RV) invented this antenna in 1946 and it is popular in the United States because it can be erected as horizontal dipole or as a “sloper” (or an inverted-V) antenna. The block shown as coupler 26 may optionally include a transmatch, (i.e., an antenna tuner) enabling operation on all HF amateur radio bands (3.5-30 MHz). In this example, acceptable operation can be achieved if the dipole elements 22A and 22B are each 15.55 meters (51.0 ft) long and the impedance-matching symmetric feedline (e.g. ladderline 24) can be either 300 Ω (if length is 8.84 meters or 29.0 feet) or 450 Ω (if length is 10.36 meters or 34.0 feet), when the height of the G5RV dipole antenna 20 above the ground is at least half of the longest wavelength to be used. Even when properly set up, the prior art HF antenna system 20 of FIG. 1G typically exhibits performance gaps in certain portions of the HF frequency band, performing well in some parts of the HF band and poorly in other parts of the band, and the radiation pattern works well at some azimuth and take-off angles but poorly in others, meaning this antenna is large and requires some on-site trial and error work when setting up and orienting the antenna dipole elements 22A, 22B.

Users of newer wideband HF radios aim to utilize much higher instantaneous bandwidth to provide higher data rates for modern applications. But traditional HF antenna systems (e.g., 10, 12, 16 or 20) are not well suited for convenient, reliable setup and use with such newer radios and so require adjustment with external tuner equipment to properly interface to the radio system. These added external tuners add cost, complexity and potential failure modes to the other issues facing communication system operators.

So the prior art antennae designed for dedicated use with regular HF or NVIS systems are not necessarily portable or compact enough and while they may do a relatively effective job of launching energy into a vertical direction at some frequencies, they are not reliably effective for other, more modern HF communications over longer distances or with more complicated waveforms, and those HF antennae designed for longer range communications are large, difficult to set up, and not well suited for modern HF communications (reliably providing instantaneous 3-30 MHz bandwidth for global communications capability with consistent gain, VSWR and radiation patterns, for quickly establishing communications and transmitting the more modern, complicated waveforms.)

There is a need, therefore, for a transportable HF antenna system and method which overcomes those shortcomings.

### SUMMARY

This Summary of the present disclosure is provided to introduce a selection of representative concepts in a simplified form, which representative concepts are further described below in the Detailed Description of Exemplary Embodiments. This Summary section is not intended to identify key features or essential features of the claim-like statements listed below as numbered clauses or of the appended claims, nor is it intended to be used to limit the scope of those claim-like statements or appended claims.

An aspect of the present disclosure provides a transportable, rapidly deployable, High-Frequency (HF) horizontal fan antenna system and method which overcomes the above identified shortcomings. There are two embodiments, namely (a) an eXpeditionary HF (“X_{HF}”) antenna and coupling system and method, and (b) an enhanced NVIS expeditionary (“ENV-2”) antenna and coupling system and method.

In a first exemplary embodiment, The easily transportable, rapidly deployable eXpeditionary HF (“X_{HF}”) antenna and coupling system and method of the present invention provides surprising performance capabilities for expeditionary (e.g., military) HF wireless communication applications. The horizontal fan antenna system of the present invention packs into two or three transit cases (one for a segmented or extendable mast pole) that can be transported by a single individual and can be set up by two individuals within 60 minutes. This reduced form factor and simplicity of installation and operation is achieved without compromising performance. In fact, the X_{HF} horizontal fan antenna of the present invention provides performance not matched by any other HF antenna system currently on the market in terms of instantaneous bandwidth, gain, and VSWR. As noted above, traditional HF antennas typically exhibit performance gaps in certain portions of the HF frequency band, performing well in some parts of the HF band and poorly in other parts of the band. The X_{HF} horizontal fan antenna provides consistent performance across the entire HF frequency band without meaningful deviations in performance, and can support the increased bandwidth and complex waveforms of modern HF radio system (e.g., such as the newer wideband HF radios which are configured to utilize much higher instantaneous bandwidth and provide higher data rates for modern applications).

The easily transportable, rapidly deployable eXpeditionary HF (“X_{HF}”) antenna system and method of the present invention was designed using significant modeling, simulation, and optimization development work involving various antenna system configurations, and the applicants'best performing prototypes demonstrated a unique and surprisingly effective combination of improved gain, voltage standing wave ratio (VSWR), and simultaneous bandwidth support in form factors needed for expeditionary uses (generally significantly better than the closest comparable prior art Commercial-off-the-Shelf (“COTS”) antenna systems). The X_{HF} antenna system embodiments of the present invention have also been evaluated in a variety of real-world conditions with results that match or exceed modelling predictions. Furthermore, a novel antenna coupling technology has proven to be far simpler and more reliable and provides greater useful bandwidths than prior art (including existing COTS) HF coupler technology.

The eXpeditionary High-Frequency (X_{HF}) Horizontal Fan antenna system is configured to provide wideband, global communications (transmit and receive) in the HF frequency band in a highly portable, easily setup form factor. The X_{HF} Horizontal Fan antenna system can support Near-Vertical Incident Skywave (NVIS) as well as medium and long range HF communications. The X_{HF} horizontal fan antenna system has been designed to provide consistent gain and Voltage Standing Wave Ratio (VSWR) across the entire HF frequency band without significant variations in performance. The X_{HF} Horizontal Fan antenna system supports instantaneous reception across the entire 3-30 MHz HF frequency band without the use of any external Radio Frequency (RF) components or Radio (e.g., transceiver, transmitter or receiver) modifications and supports instantaneous transmission in the 7-30 MHz HF frequency band and supports transmit power of more than 1000 Watts. The X_{HF} Horizontal Fan antenna system supports transmit capabilities in the 3-7 MHz HF frequency band by adding only a fixed 3 dB attenuation (properly rated for the power output of the radio in use by the operator) inline between the radio and antenna system.

The easily transportable, rapidly deployable eXpeditionary HF (“X_{HF}”) antenna system includes first and second opposing dipole planar fan-shaped antenna assemblies which are each comprised of a plurality of (e.g. two, three or five) metal alloy (e.g., 1/16 inch diameter steel) wire segments sloping down from a mast top connection at a selected fan member slope angle of approximately 45 degrees below a horizontal plane, where they are held in their planar sloped orientation by insulated guy wires. Each of the first and second opposing dipole planar fan-shaped antenna assemblies has at least a first outer wire segment or element angularly arrayed from a second outer wire segment or element by an inter-element fan spread angle of between 20 and 30 degrees (preferably 25.66 degrees) so that the lateral distance between the lower ends of the dipole fan outer wire segments or elements is 15 feet (plus or minus two feet). For each fan assembly, the length of the first and second outer wire segments or elements (from the mast top connector to the distal or bottom end) is preferably 31-35 feet (with a tolerance of minus one foot and plus two feet). When erected by users at the site, the conductive distal ends the wire segments or elements of the first and second opposing dipole planar fan-shaped antenna assemblies are 51 feet from one another (plus or minus two feet) and are supported by nonconductive guy lines under tension at a a selected height (e.g., 6-7.5 feet (plus or minus one foot)) above the ground

The simplest embodiment of the present invention is the enhanced NVIS expeditionary (“ENV-2”) antenna and coupling system (e.g., including a 9:1 balun) and method which is preferably packaged in a kit in one luggage case (also suitable for transport as checked baggage on an airline). The enhanced NVIS expeditionary (“ENV-2”) antenna kit is preferably used with a customer supplied 40 foot central support or mast and includes longer two-wire antenna assemblies having only the first outer wire segment or element which is, when erected, angularly arrayed from the second outer wire segment or element by an inter-element fan spread angle of between 10 and 20 degrees (preferably 12.48 degrees). The enhanced NVIS expeditionary (“ENV-2”) antenna wire segments or elements longer, so each has a length, when erected, of preferably 69 feet (with a tolerance of minus one foot and plus two feet). Each wire element or segment has a resistor at the element midpoint (preferably at 34 feet six inches), so that the lateral distance between the lower or distal ends of the dipole fan outer wire segments or elements is preferably 15 feet (plus or minus two feet). When erected by users at the site, the conductive distal ends the wire segments or elements of the first and second opposing dipole planar fan-shaped antenna assemblies are 121 feet from one another (plus or minus two feet) and are supported by nonconductive guy lines under tension at a selected height (e.g., 6-7.5 feet (plus or minus one foot)). The eXpeditionary High-Frequency (XHF) enhanced Near Vertical Incidence Skywave (“NVIS”) Antenna System and Method embodiment of the present invention provides surprising performance capabilities for easily transportable, expeditionary (e.g., military) HF wireless communication applications.

Returning to the eXpeditionary HF (“X_{HF}”) antenna embodiments, the dipole's first and second fan-shaped antenna assemblies include an added coplanar central wire segment or element extending from the mast top connection along a bisecting axis between the first and second outer wire segments or elements. The length of the central wire segment or element (from the mast top connector to the distal or bottom end) is preferably 33 feet (with a tolerance of minus one foot and plus two feet), and being in a coplanar alignment with the first and second outer elements, has its conductive distal end 51 feet from the corresponding central wire segment or element on the opposing dipole fan (plus or minus two feet) and is also supported by nonconductive guy lines under tension at a selected height (e.g., 6-7.5 feet (plus or minus one foot)) above the ground. A second embodiment has a plurality of transverse coplanar wire segments or elements conductively connected to each of the outer wire segments or elements to configure each dipole fan assembly as a wire element mesh having a fifteen foot long bottom transverse wire segment or element connected to the distal lower ends of the outer elements and the central element.

A third embodiment of the dipole's fan-shaped antenna assemblies include fourth and fifth coplanar wire segments beside the central wire segment or element extending from the mast top connection and evenly spaced at the same angle from the central bisecting axis between the first and second outer wire segments or elements to provide five angularly arrayed wire segment or elements. The fourth and fifth coplanar wire segments or elements are each preferably 33.21 feet in length (from the mast top connector to their distal or bottom ends, with a tolerance of minus one foot and plus two feet) and they are spaced in an even radial array 6.415 degrees apart (plus or minus 2 degrees). In this third “5 wire” embodiment, once set up (in accordance with the method of the present invention in a coplanar alignment with the center element and the first and second outer elements, the conductive distal ends of all five radially arrayed wire elements are 51 feet from the corresponding ends of the five wire elements on the opposing dipole fan (plus or minus two feet) and are also supported by nonconductive guy lines under tension a selected height (e.g., 6-7.5 feet (plus or minus one foot)) above the ground.

The X_{HF} (i.e. not EN-2) embodiment of the present invention packs into three transit case that can be transported as checked luggage and can be set up by two individuals in 30 minutes or less, and once erected or assembled on a chosen site, provides wideband, global communications (transmit and receive) in the HF frequency band. The X_{HF} ENV-2 antenna is optimized for low-frequency NVIS HF communications (3 to 10 MHz) but also provides surprisingly consistent gain and Voltage Standing Wave Ratio (VSWR) across the entire HF frequency band without significant variations in performance in azimuth. For the NVIS embodiment, gain performance is lower for long-range communications (i.e., at lower take-off angles) due to the antenna pattern designed to be optimal at a 90 degree takeoff angle (i.e., straight up), but the NVIS embodiment (aka the X_{HF} ENV-2) still provides relatively strong long-range communications. The X_{HF} ENV-2 antenna system, once erected on site, also supports instantaneous transmission or reception across the entire 3-30 MHz HF frequency band without the use of any external Radio Frequency (RF) components or radio transmitter/receiver modifications and accepts input (transmitter) power of up to 1000 Watts.

More generally, any of the transportable rapidly deployable High-Frequency (HF) horizontal fan antenna system embodiments described above are adapted for NVIS propagation (e.g., paths 2 and 4 in FIG. 1A) or long skip HF propagation (e.g., path 6 in FIG. 1A) and comprise a transportable HF dipole fan antenna assembly configured for support by a central mast providing first and second central elevated attachments and electrical connections to the tops of a dipole pair of fan antenna assemblies which are radially arrayed at substantially 180 degrees from one another while fitting within a short horizontal distance (e.g., of less than 52 feet for the eXpeditionary HF (“X_{HF}”) antenna) between the opposing bottom or distal ends of the wire elements of the opposing fan assemblies. Surprisingly, the transportable HF dipole antenna system of the present invention provides a VSWR of less than 2 over a frequency range of 8 MHz to 30 MHz while providing a horizontal fan radiation pattern at a horizontal or long skip takeoff angle of 20 degrees that varies (gain) in the range of 0 db to −5 dB for HF frequencies in the range of 3 MHz to 15 MHz, so expeditionary users can set up the X_{HF} antenna system of the present invention quickly and are more likely to immediately receive signals from nearly any azimuth without undue dipole element setup or aiming trial and error. This kind of compactness and ease of use (performance) are significant improvements over what the prior art can provide.

The above and still further objects, features and advantages of aspects of the present invention will become apparent upon consideration of the following detailed description of a specific embodiment thereof, particularly when taken in conjunction with the accompanying drawings, wherein like reference numerals in the various figures are utilized to designate like components.

### BRIEF DESCRIPTION OF THE SEVERAL VIEWS OF THE DRAWINGS

The drawings referenced herein form a part of the specification and are incorporated herein by reference. At least some of those drawings are schematic in nature. Features shown in the drawings are meant as illustrative of one or more embodiments by way of example only, and not necessarily illustrative of all embodiments, unless otherwise explicitly indicated.

FIGS. 1A-1G are drawings and diagrams illustrating prior art HF and NVIS antenna systems and methods, and provide useful nomenclature for background purposes.

FIG. 2 is a diagram illustrating a perspective view of a transportable expeditionary HF antenna system and showing the first and second sloped planar dipole antenna assemblies, once assembled and erected, in accordance with exemplary embodiments of the present invention.

FIG. 3 is a diagram illustrating a side view in elevation of the transportable expeditionary HF antenna system of FIG. 2 showing the first and second sloped planar dipole antenna assemblies, once assembled and erected, in accordance with exemplary embodiments of the system and method of the present invention.

FIG. 4 is a diagram illustrating a plan view from above of the transportable expeditionary HF antenna system of FIGS. 2 and 3 showing the selected site and central elevated support or mast and an array of ground stakes positioned to support the first and second sloped planar dipole antenna assemblies, once assembled and erected, in accordance with exemplary embodiments of the system and method of the present invention.

FIG. 5 is a diagram illustrating a side view in elevation of the transportable expeditionary HF antenna system of FIGS. 2-4 showing the orientations and wire element lengths of the first and second sloped planar dipole antenna assemblies, once assembled and erected, in accordance with exemplary embodiments of the system and method of the present invention.

FIG. 6 is a layout diagram illustrating a plan view from above of the transportable expeditionary HF antenna system of FIGS. 2-5 showing one side of the selected site and central elevated support or mast supporting one of the sloped planar dipole antenna assemblies, once assembled and erected and tensioned by guy ropes or cords to the ground stakes, in accordance with exemplary embodiments of the system and method of the present invention.

FIG. 7 is a photograph of an X_{HF} antenna kit case with disassembled components (including a base assembly) suitable for use in a user manual or setup guide instructing expeditionary antenna system users how to assemble, erect and use the expeditionary HF antenna system of exemplary embodiments of the present invention, including those of FIGS. 1-6.

FIG. 8 is a photograph of the assembly method for a X_{HF} antenna mast assembly with partially assembled components suitable for use in a user manual or setup guide instructing expeditionary antenna system users how to assemble, erect and use the expeditionary HF antenna system of exemplary embodiments of the present invention, including those of FIGS. 1-7.

FIG. 9 is a photograph illustrating the assembly method for the X_{HF} antenna system showing the mechanical and electrical connections between the mast, the balun assembly and the first and second dipole antenna assemblies, with partially assembled components, suitable for use in a user manual or setup guide instructing expeditionary antenna system users how to assemble, erect and use the expeditionary HF antenna system of exemplary embodiments of the present invention, including those of FIGS. 1-8.

FIG. 10 is a photograph of the X_{HF} antenna mast system erected on a selected site suitable for use in a user manual or setup guide instructing expeditionary antenna system users how to assemble, erect and use the expeditionary HF antenna system of exemplary embodiments of the present invention, including those of FIGS. 1-9.

FIG. 11A-11C are diagrams illustrating a perspective view of another exemplary embodiment of a transportable expeditionary HF antenna system adapted especially for NVIS use, especially at lower HF frequencies (e.g., 3-10 MHz) and showing the first and second “Two Wire” sloped planar dipole antenna assemblies, once assembled and erected, in accordance with exemplary embodiments of the present invention.

FIGS. 11D-11G are diagrams illustrating characteristics and features of yet another (earlier prototype) embodiment of a transportable expeditionary HF antenna system showing the first and second “seven wire” sloped planar dipole antenna assemblies, once assembled and erected, in accordance with exemplary embodiments of the present invention.

FIG. 12 is a schematic diagram of a lumped circuit model of the expeditionary HF antenna system for exemplary embodiments of the present invention, including those of FIGS. 1-11E.

FIG. 13 is a graphical representation or data plot illustrating modelled and measured antenna SWR impedance match performance over an HF frequency range of 3 MHz to 30 MHz, in accordance with exemplary embodiments of the present invention.

FIG. 14 is a graphical representation or data plot illustrating antenna horizontal fan gain as a function of frequency over an HF frequency range of 3 MHz to 30 MHz at three upwardly sloped measurement takeoff angles (above a horizontal ground reference plane), in accordance with exemplary embodiments of the present invention.

FIG. 15 is a graphical representation or data plot illustrating antenna gain pattern, from a broadside perspective showing gain as a function measurement takeoff angle above a horizontal plane for three selected HF frequencies, namely 3 MHz, 15 MHz and 30 MHz, in accordance with exemplary embodiments of the present invention.

FIG. 16 is a graphical representation or data plot illustrating antenna azimuth gain pattern, from a plan view, above the top of the central support or mast) showing gain as a function of azimuth at a measurement takeoff angle of 20 degrees for three selected HF frequencies, namely 3 MHz, 15 MHz and 30 MHz, in accordance with exemplary embodiments of the present invention.

FIG. 17 is a graphical representation or data plot illustrating antenna azimuth gain pattern, from a plan view, above the top of the central support or mast) showing gain as a function of azimuth at a measurement takeoff angle of 45 degrees for three selected HF frequencies, namely 3 MHz, 15 MHz and 30 MHz, in accordance with exemplary embodiments of the present invention.

FIG. 18 is a graphical representation or data plot illustrating antenna SWR impedance match performance over a wideband HF frequency range of 3 MHz to 30 MHz, comparing four exemplary embodiments of the expeditionary antenna system of the present invention with different excitation options.

FIG. 19 is a graphical representation or data plot illustrating antenna SWR impedance match performance over a narrower band of the HF frequency range (3 MHz to 10 MHz), comparing the same four exemplary embodiments of the expeditionary antenna system of FIG. 18, in accordance with the present invention.

FIG. 20 is a graphical representation or data plot illustrating antenna gain performance over a wideband HF frequency range of 3 MHz to 30 MHz, comparing the same four exemplary embodiments of the expeditionary antenna system of FIGS. 19 and 20, in accordance with the present invention.

FIG. 21 is a graphical representation or data plot illustrating antenna gain performance over a narrower band the HF frequency range (3 MHz to 10 MHz), comparing the same four exemplary embodiments of the expeditionary antenna system of FIGS. 19-21, in accordance with the present invention.

### DETAILED DESCRIPTION OF THE EXEMPLARY EMBODIMENTS

It will be readily understood that the components and features of the exemplary embodiments, as generally described herein and illustrated in the Figures, may be arranged and designed in a wide variety of different configurations. Thus, the following detailed description of the embodiments of the methods, devices, assemblies, apparatus, systems, products, modules, submodules, etc. of the exemplary embodiments, as presented in the Figures, is not intended to limit the scope of the embodiments, as recited in the accompanying claims, but is merely representative of selected embodiments.

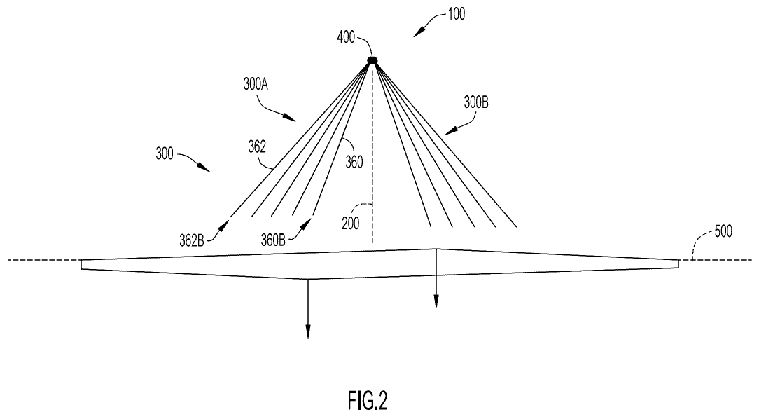

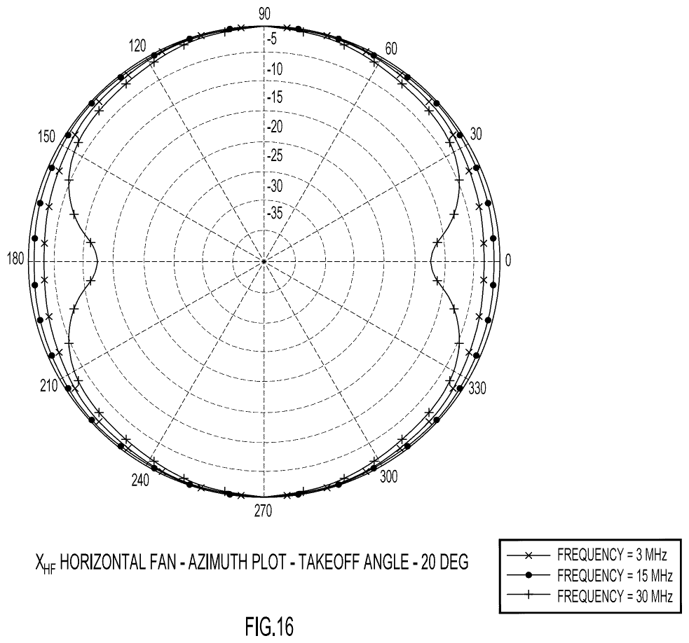

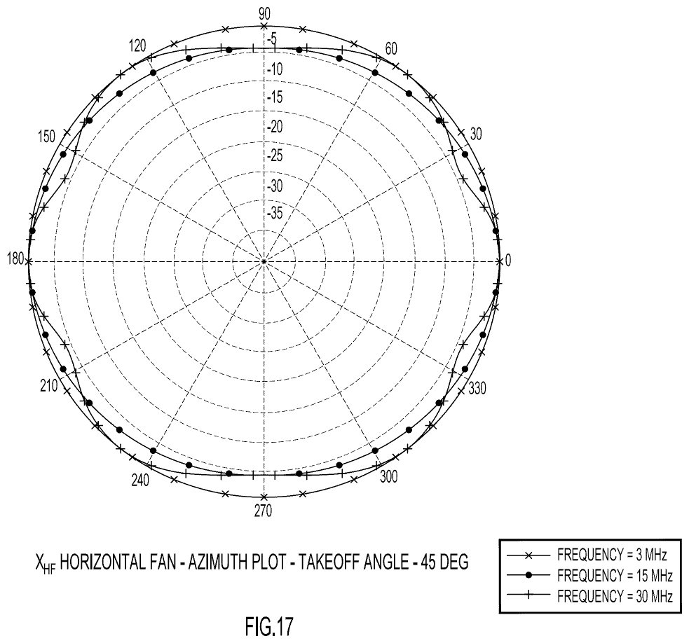

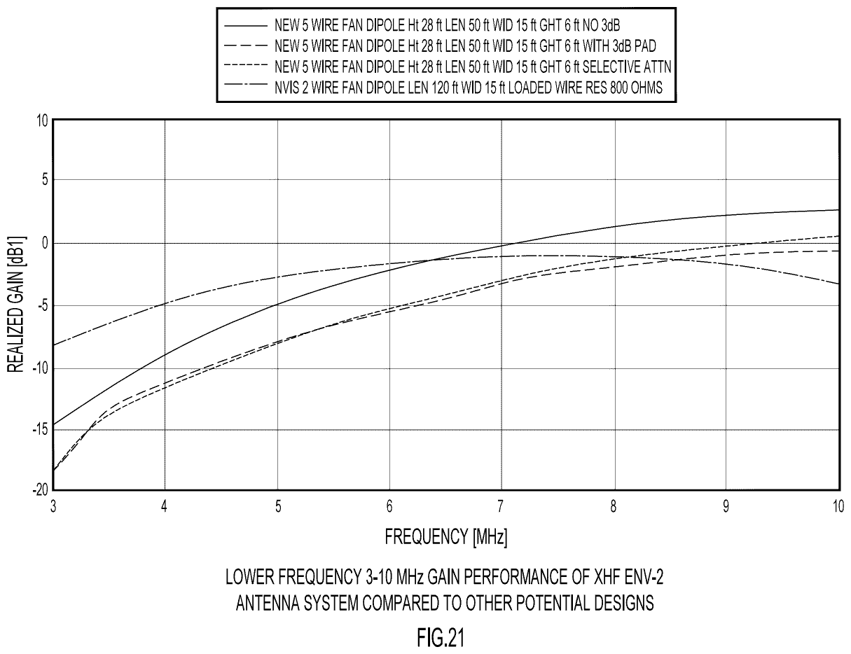

The illustrated embodiments will be best understood by reference to the drawings of FIGS. 2-21), wherein like parts are designated by like numerals throughout. The following description is intended only by way of example, and illustrates certain selected embodiments of methods, devices, assemblies, apparatus, systems, products, modules, submodules, etc. that are consistent with the embodiments as received in the accompanying claims.

Reference throughout this specification to “a select embodiment,” “one embodiment,” “an exemplary embodiment,” “exemplary embodiments,” “an embodiment,” “embodiments,” or the like means that a particular feature, structure, or characteristic described in connection with the embodiment(s) is included in at least one embodiment. Thus, appearances of the phrases “in a select embodiment,” “in one embodiment,” “in an exemplary embodiment,” “in exemplary embodiments,” “in an embodiment,” “in embodiments,” or the like in various places throughout this specification are not necessarily referring to the same embodiment(s) or only a single embodiment. The embodiments may be, for example, combined with one another in various combinations and modified to include features of one another.

Generally, one or more exemplary embodiments described herein provide systems, products and other articles, and processes and methods of transporting erecting and using an antenna system loudspeaker system in a particular expeditionary location or other environment through the use of assemblies of antenna and radio components or the like that would otherwise be unobtainable or extremely difficult, impractical, and/or expensive. Ideally, execution or implementation of one or more exemplary embodiments enables an expeditionary communication system user to transport, assemble, erect and use their antenna system in very challenging locations and operational conditions.

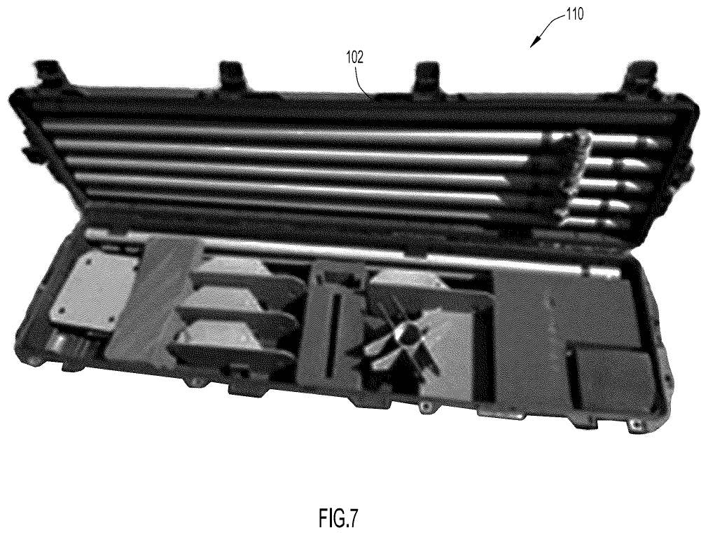

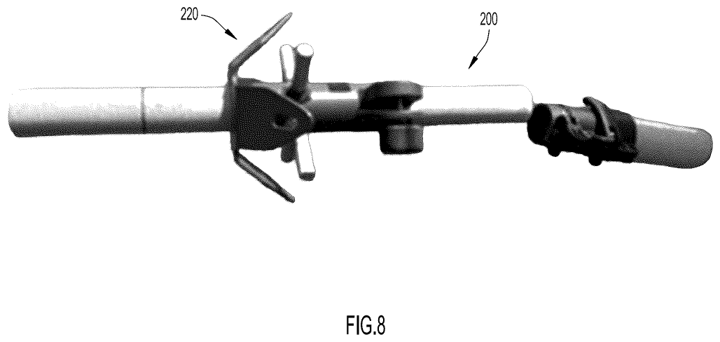

The easily transportable, rapidly deployable eXpeditionary HF (“X_{HF}”) antenna system (e.g., 100) of the present invention is configured as an X_{HF} system kit in disassembled components preferably packed in three transportable cases (e.g., such as the Pelican™ style case 102 shown in FIG. 7, which contains disassembled parts of the base (e.g., 110).

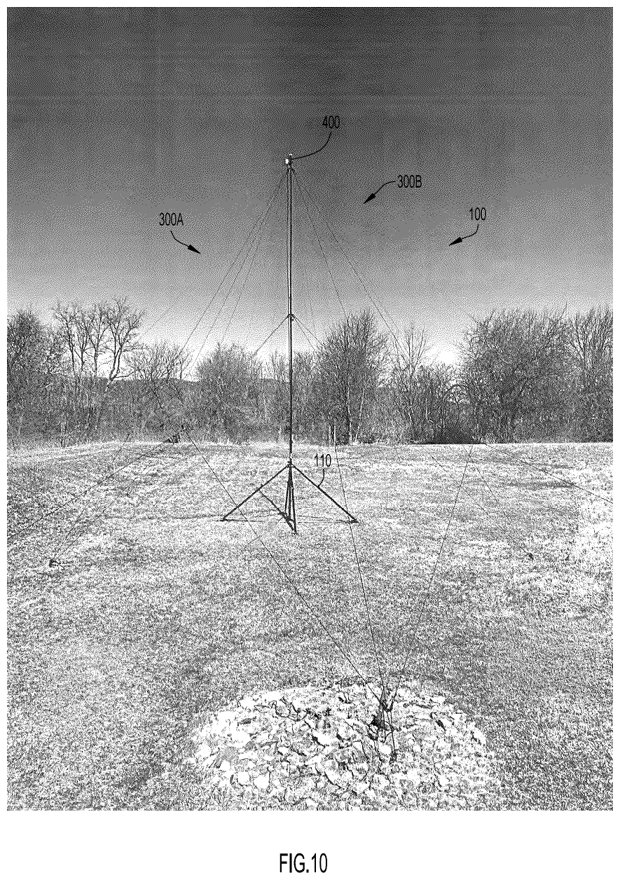

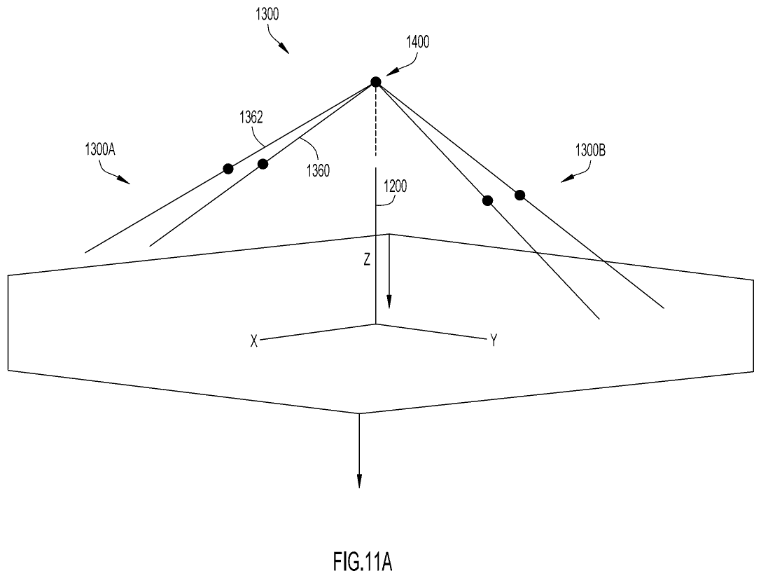

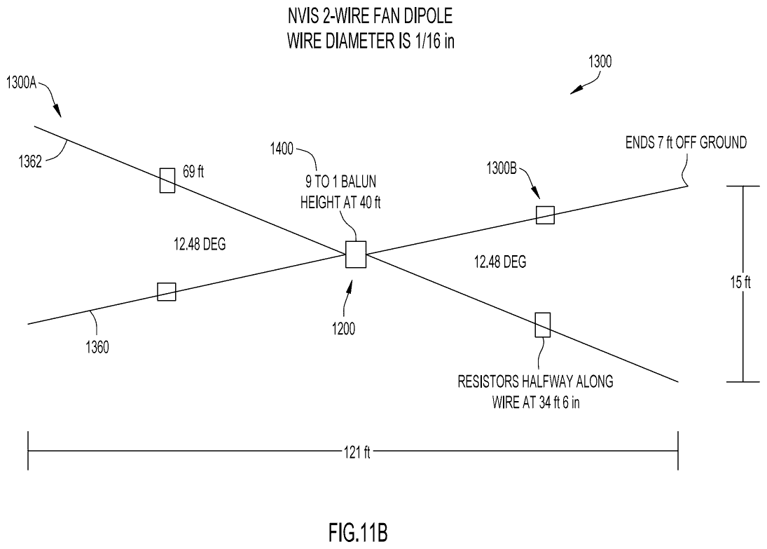

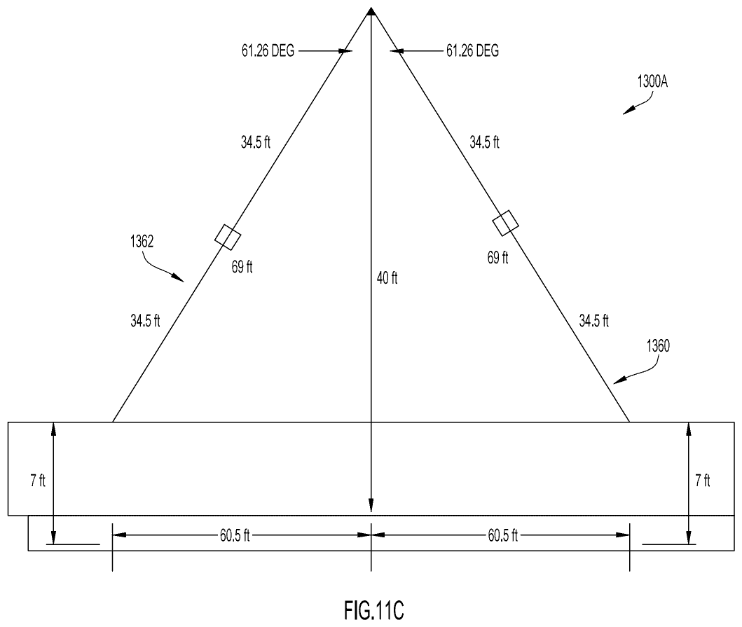

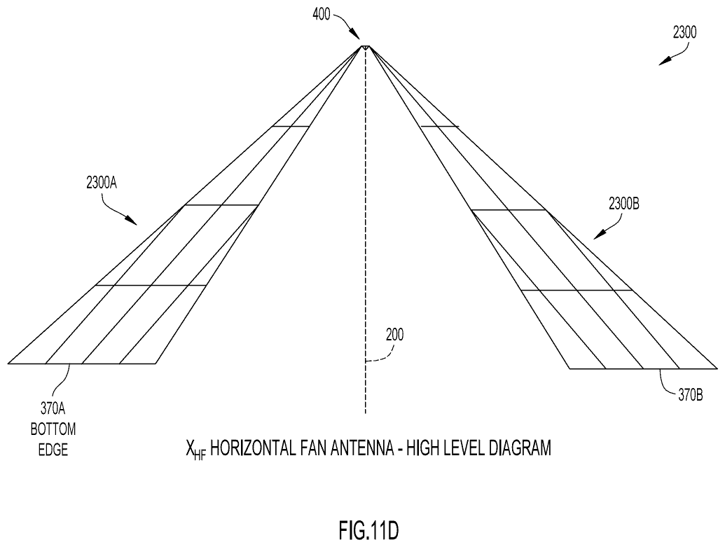

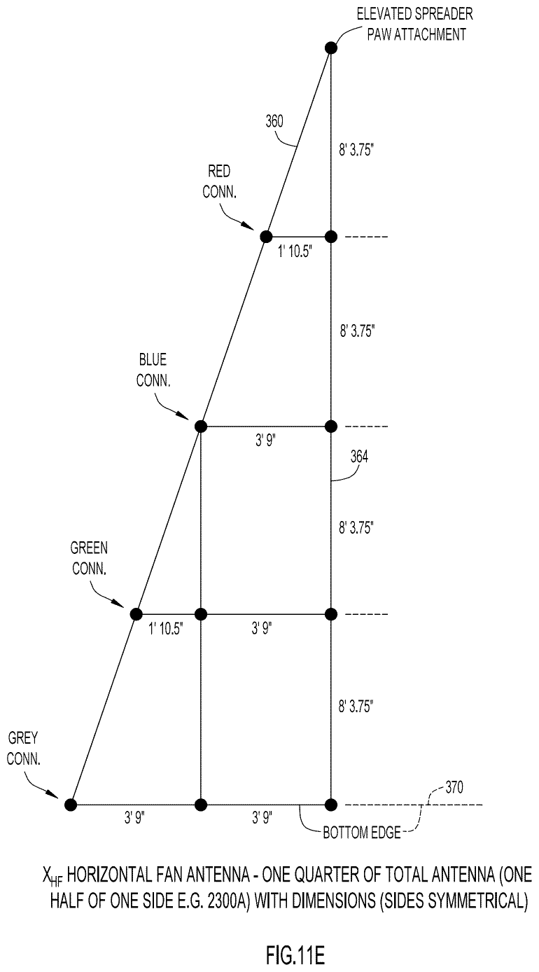

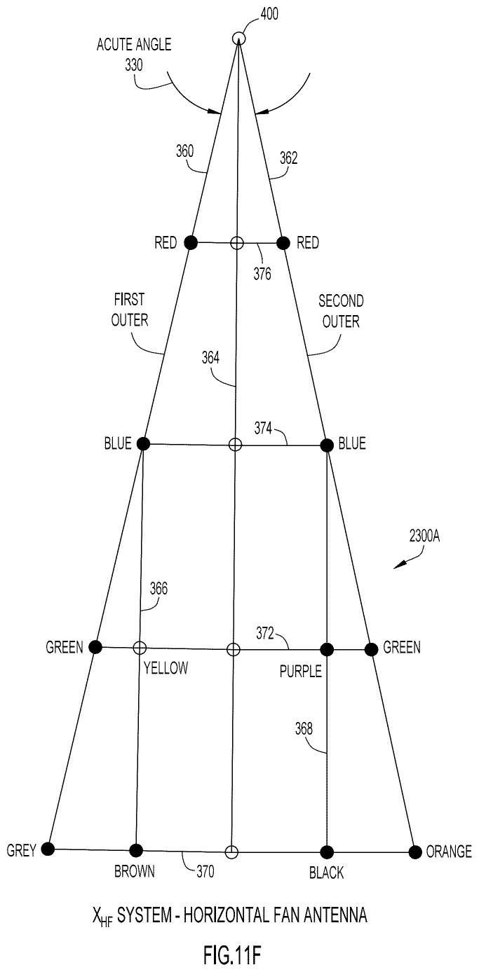

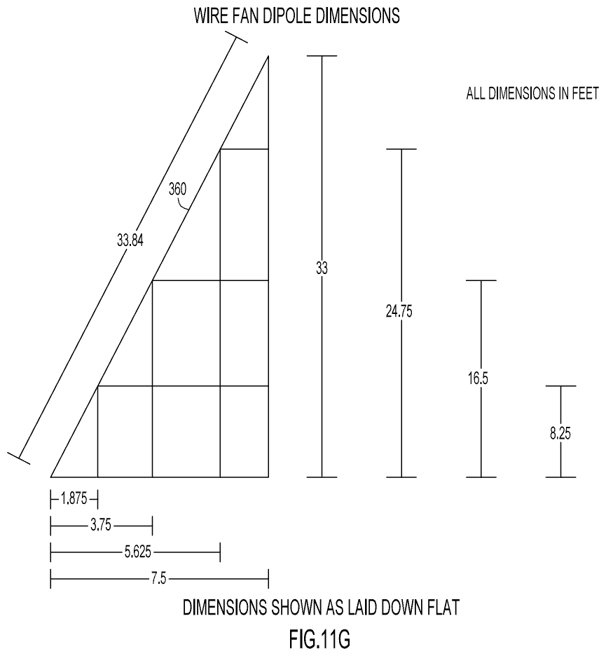

There are two main embodiments for the improved HF antenna systems of the present invention, namely (a) the X_{HF} (e.g., 5 wire) Horizontal Fan antenna system 100 as illustrated in FIGS. 2-10, and (b) the eXpeditionary High-Frequency (X_{HF}) Enhanced NVIS 2-Wire (ENV-2) antenna system with a simpler 2 wire fan antenna assembly (e.g., 1300A and 1300B) as illustrated in FIG. 11A, and they differ mainly in the number of fan shaped antenna assembly wire segments or elements in each of the first and second opposing dipole planar fan-shaped antenna assemblies (e.g., having fewer elements than 300A and 300B) as seen in FIGS. 2-6 and the photograph of FIG. 10.

### X_{HF} Antenna System With Five Wire Dipole Fan Assembly Embodiment

Turning now to the X_{HF} (e.g., 5 wire) Horizontal Fan antenna system 100 as illustrated in FIGS. 2-6 and the photographs of FIGS. 7-10, X_{HF} horizontal fan antenna system 100 consists of three primary components: 1) Base Assembly 110, 2) Mast Assembly 200 and 3) Fan Dipole Antenna Assembly 300 (comprising first fan antenna assembly 300A and second fan antenna assembly 300B. A fourth component in the illustrated embodiment is Balun assembly 402 which is preferably mounted near the top of the mast (e.g., at 400). Balun assembly 402 is connected to a first spreader paw connection member 410A for first fan antenna assembly 300A and a second spreader paw connection member 410B for the second fan antenna assembly 300B. The base assembly 110 is a collapsible quad-leg system that supports the mast 200 in a substantially vertical orientation. Base assembly 110 may consist of commercial-off-the-shelf (COTS) and custom-built parts disassembled for transport and preferably provided in a transportable case 102, as seen in FIG. 10.

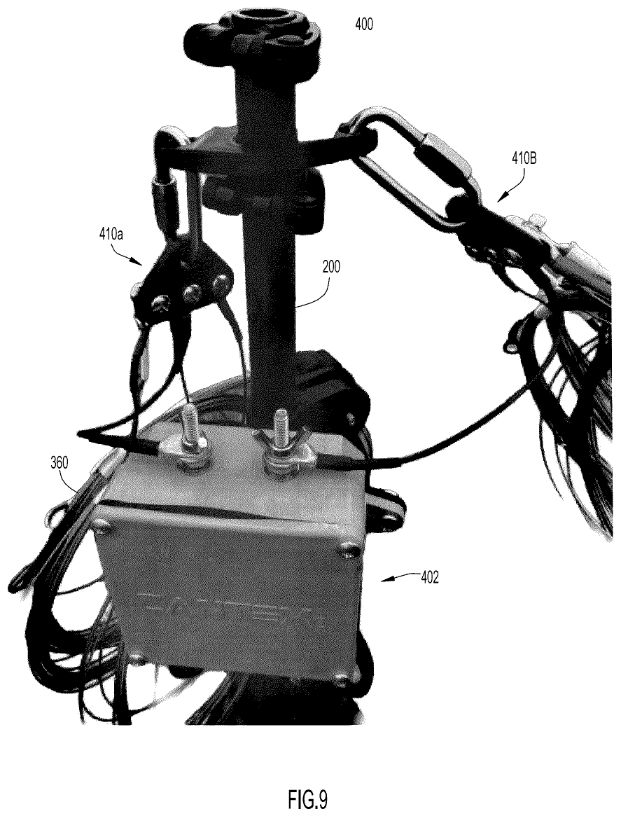

Mast assembly 200 may be configured as a sectioned or telescoping durable electrically non-conductive (e.g., fiberglass) pole that is extended or erected to provide an upper or releasable connection (e.g., via first and second conductive spreader paw connector members 410A, 410B) supporting the upper ends of first fan antenna assembly 300A and second fan antenna assembly 300B at a selected vertical height above the earth (e.g., 29 feet, as illustrated in FIGS. 2, 3, and 10). In the illustrated embodiment, during assembly (e.g., as shown in FIG. 9) the first and second conductive spreader paw connector members 410A, 410B are electrically connected to and physically near the Balun assembly 402 which are also electrically connected or conductively bonded to first fan antenna assembly 300A and second fan antenna assembly 300B of HF fan dipole antenna assembly 300.

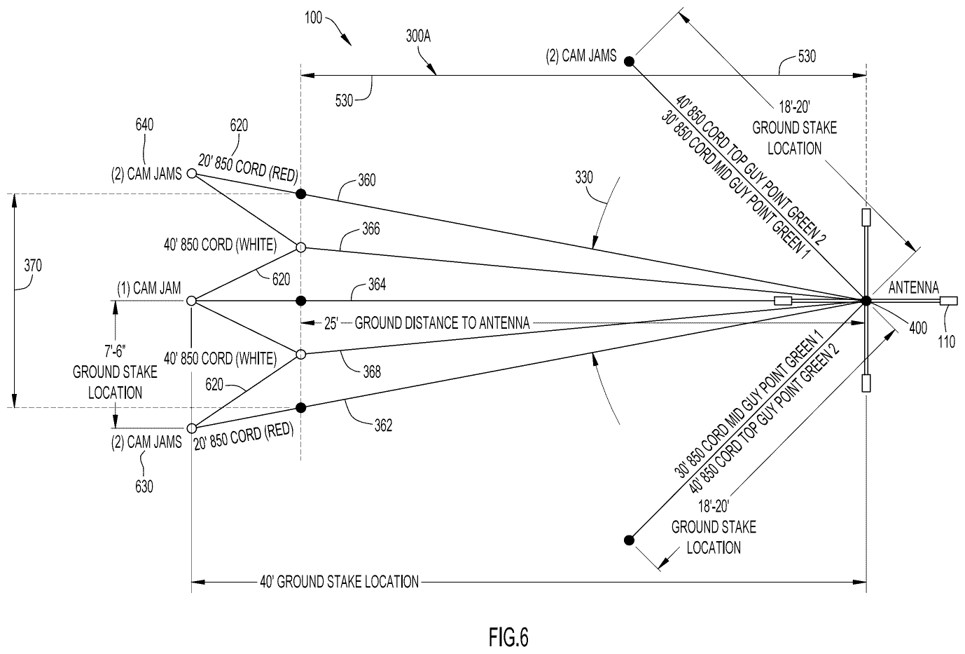

Referring back to FIGS. 2-6, HF fan dipole antenna assembly 300 comprises first and second opposed antenna assemblies 300A and 300B, each assembled from a plurality of (e.g., two or more) connected conductive wire segments or elements (preferably metal alloy, e.g., steel, aluminum or copper alloy such as steel wire of 1/16 ″ diameter), as illustrated in FIGS. 2-6 and 10. The assembly instructions for each fan antenna system 100 and the fan assemblies (e.g., 300A or 300B) preferably include photographs illustrating the assembly method of the present invention like FIGS. 7-10 and diagrams with notes and illustrations such as those shown in FIGS. 2-6. In the dipole fan assembly example embodiment illustrated in FIGS. 2-6, five long wire elements (namely first outer wire element 360, second outer wire element 362, central wire element 364, first medial wire element 366 and second medial wire element 368) are electrically connected together and supported at their first or top ends with threaded fasteners to a conductive spreader paw connector member (see e.g., 410A) with wire element or segment length dimensions and angular orientations as seen in FIGS. 5 and 6 and described below.

### eXpeditionary HF (“X_{HF}”) Antenna System Assembly and Setup Method

Referring next to FIGS. 11A-11C, applicants'enhanced NVIS expeditionary (“ENV-2”) antenna and coupling system 1300 is also initially configured in kit form with disassembled components, but in a preferred embodiment is configured for use with a customer supplied mast and so includes only first two wire fan assembly 1300A and second two wire fan assembly 1300B with a mast top connected balun assembly 1400. This kit fits into one cases (e.g., 102) which may be carried by one person and checked as luggage on commercial flights. The enhanced NVIS expeditionary (“ENV-2”) antenna and coupling system is preferably configured with a balun assembly 1400 configured to be mounted at or near the top of a customer supplied mast (e.g., 1200) and includes a 9:1 balun). The enhanced NVIS expeditionary (“ENV-2”) antenna kit is preferably used with a customer supplied 40 foot central support or mast and includes longer two-wire antenna assemblies (e.g., 1300A and 1300B), each having only a first outer wire segment or element which is, when erected, angularly arrayed from a second outer wire segment or element by an inter-element fan spread angle of between 10 and 20 degrees (preferably 12.48 degrees, see, e.g., FIG. 11B). The enhanced NVIS expeditionary (“ENV-2”) antenna fan wire segments or elements comprise assemblies with a mid-point resistor and so are longer than for other embodiments. Each ENV2 fan antenna comprises first and second wire segment assemblies with a proximal wire segment, a mid-point resistor and a distal wire segment, so each ENV2 wire segment assembly (e.g. 1360, 1362), has a length, when erected, of preferably 69 feet (with a tolerance of minus one foot and plus two feet, see, e.g., FIGS. 11B and 11C). Each ENV2 wire segment assembly (e.g. 1360, 1362), its mid-point resistor at, preferably, 34 feet six inches. When erected as illustrated in the ENV2 user guide and illustrated in FIGS. 11A-11C, the dipole fan width at the distal end or lower end of each ENV2 dipole fan assembly (e.g. 1300A, 1300B) is the lateral distance between the lower or distal ends of the dipole fan outer wire segments or elements, preferably 15 feet (plus or minus two feet). When erected by users at the site, the conductive distal ends the wire segments or elements of the first and second opposing ENV2 dipole planar fan-shaped antenna assemblies are 121 feet from one another (plus or minus two feet) and are supported by nonconductive guy lines under tension at a selected height of preferably 7 feet above ground (plus or minus one foot).

The two wire (“XHF ENV-2”) embodiment of FIGS. 11A-11C is the least expensive to produce and the easiest to set up, and yet it provides unprecedented NVIS performance and is optimized for low-frequency NVIS HF communications (3 to 10 MHz) but also provides surprisingly consistent gain and Voltage Standing Wave Ratio (VSWR) across the entire HF frequency band without significant variations in performance in azimuth. For the NVIS embodiment, gain performance is lower for long-range communications (i.e., at lower take-off angles) due to the antenna pattern designed to be optimal at a 90 degree takeoff angle (i.e., straight up), but the NVIS embodiment (aka the XHF ENV-2) still provides relatively strong long-range communications. The XHF ENV-2 version of antenna system 100 provides low frequency NVIS performance not matched by any other HF antenna system currently on the market in terms of instantaneous bandwidth, gain, and VSWR. HF antennas that provide effective low frequency NVIS performance are typically much larger and more difficult to set up. Lastly, many traditional HF antenna systems require an external tuner to interface to a radio system. The XHF horizontal fan system of the present invention

### Requires No External Tuner.

Returning to the eXpeditionary HF (“X_{HF}”) antenna and coupling system and method illustrated in FIGS. 2-10, the first step in the method, apart from providing the X_{HF} kit, is selecting a safe and effective site (see, e.g., FIGS. 4 and 10). X_{HF} antenna system 100 should be installed in a location that provides flat and solid ground. Users should avoid sites where water may pool after precipitation. Locations of pre-existing underground infrastructure (e.g., water piping, utilities, etc.) must be ascertained and avoided or accommodated. An installation site must be selected with room for driving stakes 640 into the ground in selected positions (see FIG. 4) to secure the antenna system 100 while avoiding any possible underground infrastructure interference. An installation site must also be selected such that the antenna will not potentially encounter any overhead infrastructure (e.g., power lines). For initial site planning, the fan antenna installation area (with required guying to apply spreading tension to support the outer conductive ends of the opposing sloped dipole fan assemblies (e.g., 300A, 300B)) will extend across a roughly rectangular 50 ft by 100-ft area where tensioned guy ropes, cords or wires 620, once assembled and installed, will extend to the sides approximately 25-ft from the mast 200, and will extend along the center axis of the opposing dipole fan assembly 300 by approximately 50 feet from the mast 200, which means that users need to identify an approximate 50-ft by 100-ft installation area where mast 200 can be erected in base assembly 110 and centered in the site (see, e.g., FIGS. 4 and 6).

From an RF performance perspective, the antenna should be positioned as far away from any surrounding infrastructure as possible (likely given constraints of RF cable feed length). Structures can cause signal blockages and degrade radio performance. In particular, the antenna should be positioned as far away from metal structures as possible. Metal structures can electromagnetically interact with the antenna, leading to potential performance degradation. The antenna should be positioned as far away as possible from any type of power infrastructure. Power infrastructure, such as generators and transformers, are well known to create noise in the HF frequency band and can lead to degraded receive performance.

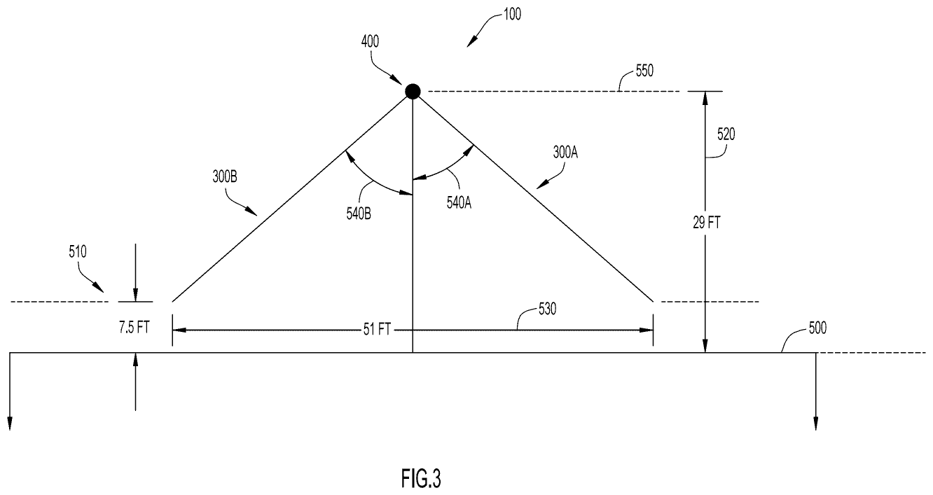

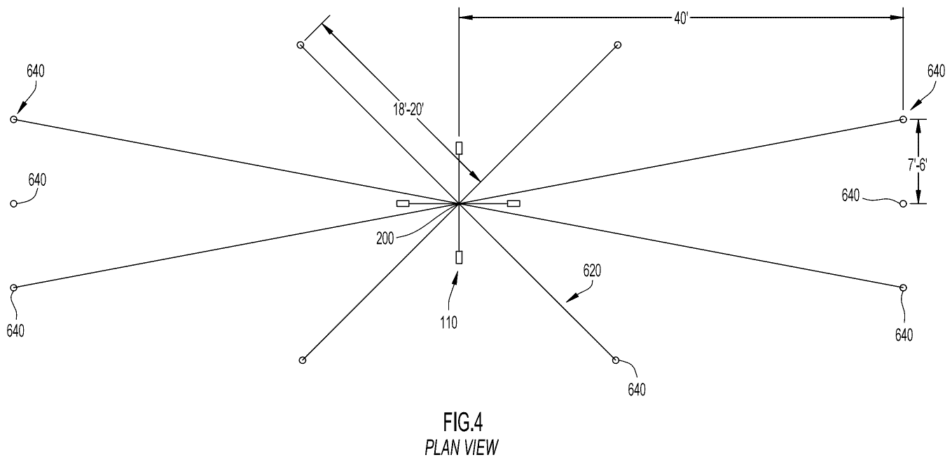

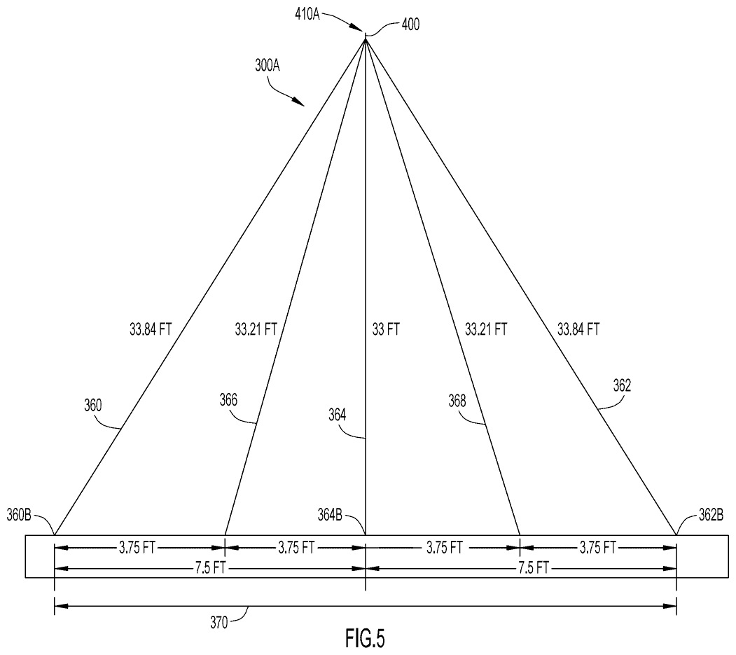

Once expeditionary site selection is complete, the users are then instructed that the installation process consists of three phases, namely, setting up the quad-leg base 110 and installing the mast 200, setting out the stakes 640 (see FIG. 4), assembling antenna system 300 and installing the antenna system 300 onto mast 200 before raising mast 200 to its full height. Guy ropes or cords 620 are used to apply centering forces by tension from stakes 640 to mid-point guy assembly (e.g., 220). An insulating split shaft collar is configured to fit at the top 400 of mast 200 and receive first and second spreader paw connector members (e.g., 410A and 410B) at or very close to the mast top 400 and then the balun assembly 402 is mounted on mast 200, close to mast top 400 so that it may be electrically connected to first and second spreader paw connector members (e.g., 410A and 410B), as illustrated in FIGS. 9 and 10. Once those components are connected together and double checked by the users at the site, the next step is to raise the mast 200 to configure the sloped dipole fan assemblies (e.g., 300A, 300B) in the elevated orientation illustrated in FIGS. 2, 3 and 10. In the illustrated example, the bottom or distal ends of the dipole fan assemblies (e.g., 300A, 300B) are supported and fixed by tensioned guy ropes (e.g. 610, preferably 850 cord), in the elevated orientation with both of the dipole fan assemblies bottom edges substantially aligned along a selected plane 510 above (e.g., 7.5 feet above) a ground reference plane 500, as shown in FIG. 3. In an alternative embodiment, the mast height 520 and top connection supporting first and second spreader paw connector members (e.g., 410A and 410B) is at 28 feet above a ground reference plane 500 and the dipole fan assembly bottom ends (at 370) are at a ground height 510 of 6 feet above ground plane 500 (with a tolerance of plus or minus one foot). For either combination of top connection height or mast height 520 and ground height 510, the elevation difference between mast height 520 and ground height 510 is preferably in the range of 21-23 feet.

In an expeditionary (e.g., military application, the site selection may require users to choose a site with uneven ground, adjustments on site may be required. Once the components are unpacked, assembled and erected into the configuration illustrated in FIG. 1010, the user adjusts tension on the guy ropes or cords 620 to provide the antenna assembly fan shapes in this orientation which provides excellent performance, as described above. There are other ways to support and orient the bottom or distal ends of the dipole fan network assemblies (e.g., 300A, 300B) in the elevated orientation with both of the dipole fan assemblies bottom edges substantially aligned along a selected plane 510 above (e.g., 7.5 feet above) a ground reference plane 500, as shown in FIG. 3 such as electrically isolated on non-conductive insulated members which are supported on the ground or from another suspending support nearby. Using any of those other fan assembly bottom support structures and methods is within the scope of this invention, so long as the antenna performance benefits described here are achieved. The process of site selection and assembling and erecting eXpeditionary HF (“X_{HF}”) antenna system 100 should be easy to complete by two able bodied user in one half hour.

### Dipole Fan Assembly Embodiment Developments

In more general terms, the easily transportable, rapidly deployable eXpeditionary HF (“X_{HF}”) antenna system 100 includes first and second opposing dipole planar fan-shaped antenna assemblies (e.g., 300A, 300B) which are each comprised of a plurality of (e.g. two, three or five) metal alloy (e.g., 1/16 inch diameter steel) coplanar wire segments sloping down from a mast top 400 supporting first and second spreader paw connecting members (e.g., 410A and 410B). As illustrated in FIG. 3, each planar dipole fan assembly (e.g., 300A, 300B) slopes down from the mast top 400 at a selected dipolar fan assembly plane slope angle (e.g., 540A, 540B) of approximately 45 degrees below a mast top level horizontal plane (e.g., 550), where they are held in their planar sloped orientation by structural supports such as tensioned insulated or nonconductive guy ropes or cords 620 (e.g., 850 cord). Each of the first and second opposing dipole planar fan-shaped antenna assemblies (e.g., 300A, 300B) comprises at least a first outer wire segment or element (e.g., 360) angularly arrayed from a second outer wire segment or element (e.g., 362) by an outer-element fan spread angle or fan assembly defining acute angle 330 of less than 45 degrees, preferably between 20 and 30 degrees (preferably 25.66 degrees) so that the lateral distance 370 between the lower or distal ends of the dipole fan outer wire segments or elements (e.g., 360B, 362B) is less than 20 feet, preferably 15 feet (plus or minus two feet) as illustrated in FIGS. 5 and 6.

For each planar dipole fan assembly (e.g., 300A), the length of the first and second outer wire segments or elements (e.g., from spreader paw connector member 410A at the mast top 400) to the distal or bottom end, (e.g., 360B, 362B) is less than 40 feet, preferably 33.84 feet (with a tolerance of minus one foot and plus two feet). The distance 370 between the fan element or segment bottom ends (e.g., 360B, 362B) is also referred to as the horizontal fan-bottom spread 370 (as seen in FIGS. 5 and 6). When antenna system 300 is assembled and erected by users at a selected site and viewed from the side (as illustrated in FIG. 3), the conductive distal ends the wire segments or elements (e.g., 360B, 362B) of the first and second opposing dipole planar fan-shaped antenna assemblies (e.g., 300A, 300B) cover a dipole sloped fan spread horizontal distance 530 of less than 60 feet, preferably 51 feet from one another (plus or minus two feet) and are supported by nonconductive guy lines or ropes 620 under tension or some other support so that for each planar fan assembly, those distal ends are aligned along a common bottom edge substantially horizontal plane 510 which is less than 10 feet and preferably 7.5 feet (plus or minus two feet) above the ground (or a reference ground plane 500). As noted above, in an alternative embodiment, the mast height 520 and top connection supporting first and second spreader paw connector members (e.g., 410A and 410B) is at 28 feet above a ground reference plane 500 and the dipole fan assembly bottom ends (at 370) are at a ground height 510 of 6 feet above ground plane 500 (with a tolerance of plus or minus one foot). For either combination of top connection height or mast height 520 and ground height 510, the elevation difference between mast height 520 and ground height 510 is preferably in the range of 21-23 feet.

### Prototype Mesh Dipole Fan Assembly Embodiment

Another early prototype embodiment of the dipole's first and second fan-shaped antenna assemblies (e.g., 2300A, 2300B) is illustrated in FIGS. 11D-11G and include coplanar outer and central wire segments or elements (e.g., 360, 362 and 364) extending from a first and second spreader paw connector members (e.g., 410A) at the mast top 400. The early prototype fan shaped antenna assembly embodiment 2300 of FIGS. 11D-11G is similar to differs from the embodiments of FIGS. 2-10 by including outer wire segments 360, 362 and central wire segment 364 in the same coplanar orientation, with two more substantially longitudinal wire segments 366, 368, making a planar array with five substantially longitudinal wire segments (e.g., 360, 362, 364, 366 and 368). In addition, these prototype fan shaped assemblies (2300A and 2300B) included a plurality of (e.g. four) transverse coplanar wire segments or elements (e.g., 370, 372, 374, 376) conductively connected to each of the outer wire elements and the central wire element by color coded connectors to make each dipole fan assembly a wire element mesh having a fifteen foot long bottom transverse wire segment or element 370 connected to the distal lower ends of the outer elements and the central element 364. The upper three transverse elements (372, 374, 376) are preferably evenly spaced above bottom transverse wire element 370 at 8.25 inch spacings (all length dimensions having a tolerance of plus one inch minus two). These wire element or segment connections can be assembled in a factory as part of the X_{HF} kit or assembled or repaired from wire segments cut and fitted in the field. The mesh fan antenna assembly's first and second medial longitudinal wire elements 366, 368 are connected at their lower or distal ends to bottom wire element 370 and to the two transverse elements (372, 374) spaced above the bottom wire element to provide a fan shaped planar conductive mesh, once assembled and erected.

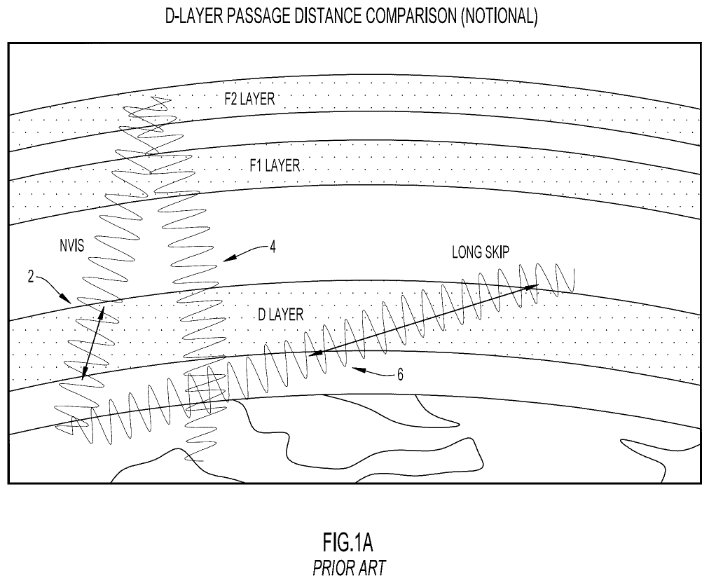

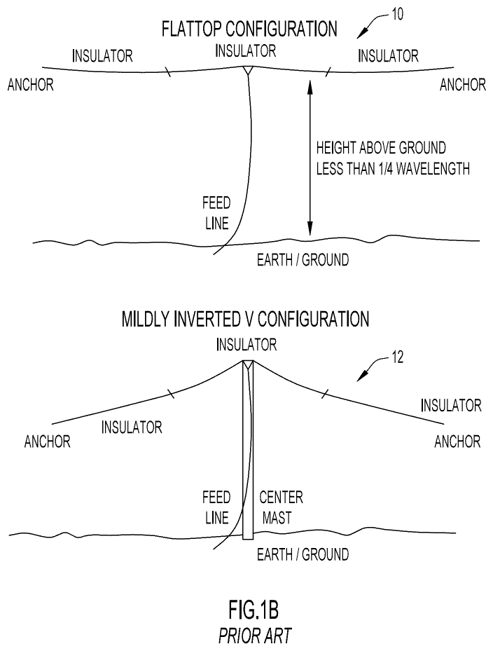

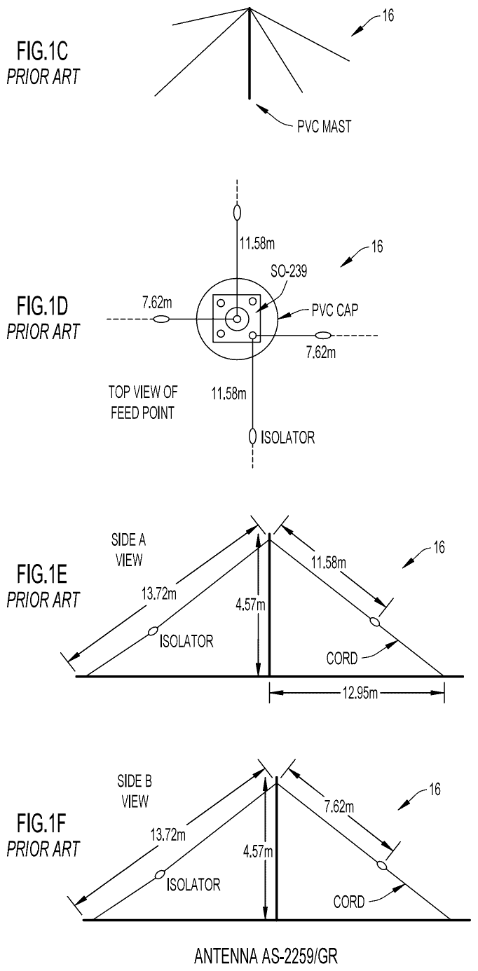

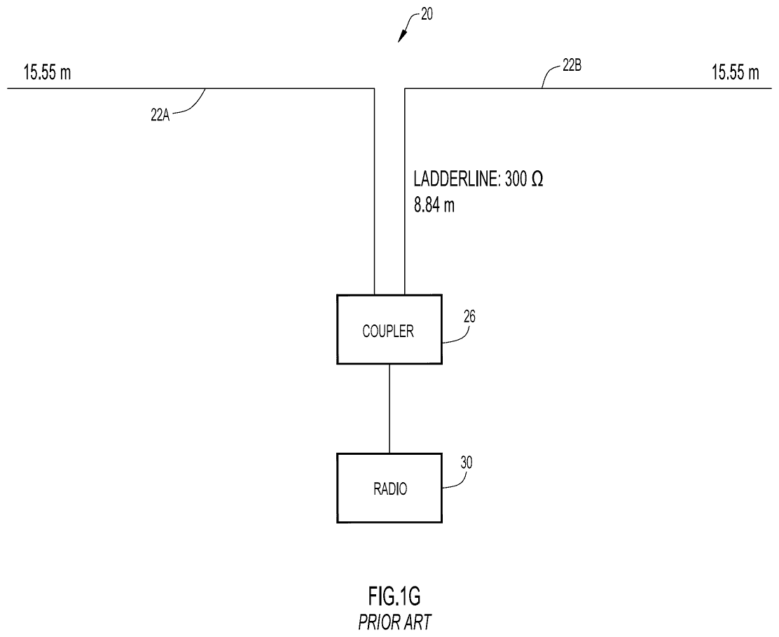

As with the embodiments described above, the X_{HF} antenna system with the mesh dipole fan assembly (e.g., 2300A) of FIGS. 11D-11G provides a rapidly deployable High-Frequency (HF) horizontal fan antenna system embodiment which is adapted for NVIS propagation (e.g., paths 2 and 4 in FIG. 1A) or long skip HF propagation (e.g., path 6 in FIG. 1A) and comprises a transportable HF dipole fan antenna assembly including a central mast providing first and second central elevated attachments and electrical connections to the tops of a dipole pair of fan antenna assemblies which are radially arrayed at substantially 180 degrees from one another while fitting within a short horizontal distance (e.g., of less than 52 feet) between the opposing bottom or distal ends of the wire elements of the opposing fan assemblies.

### System Optimization and Performance

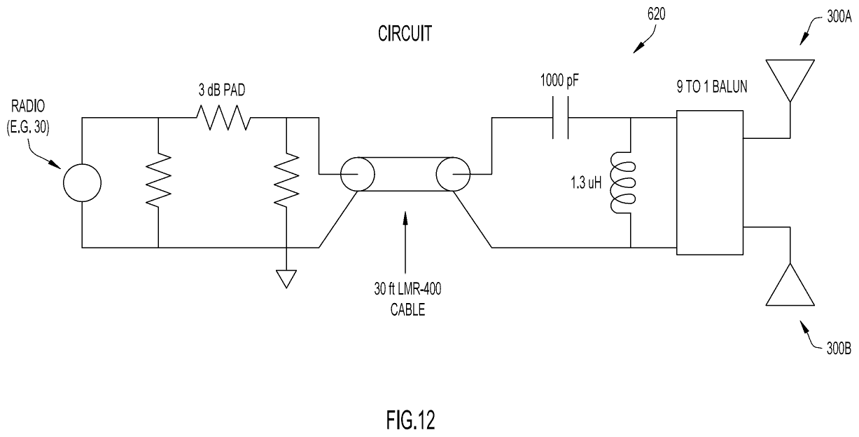

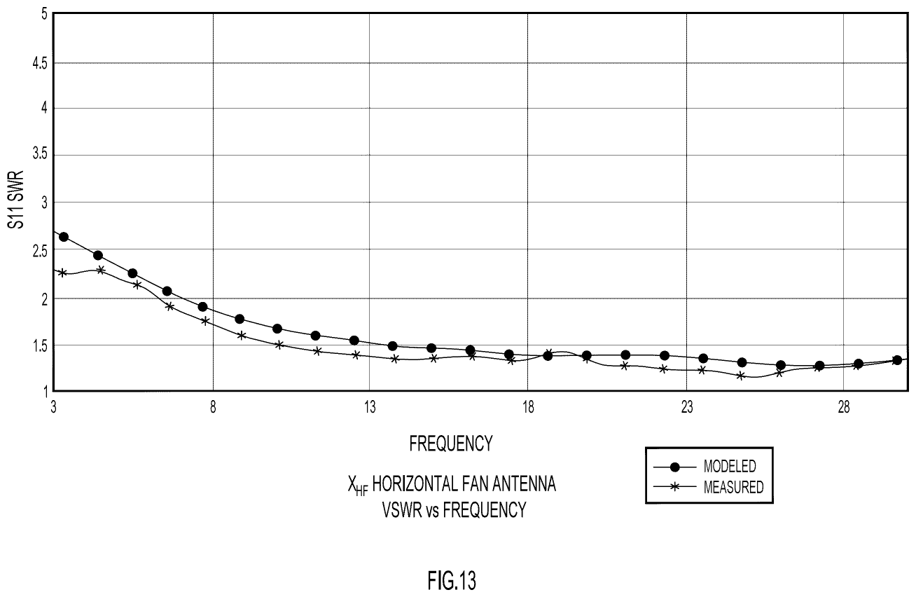

The electrical behavior of the X_{HF} antenna system of the present invention (e.g., 100, with dipole fan assemblies described and illustrated here (e.g., 300A, 2300A) may be characterized by the lumped element circuit model shown in the schematic diagram 620 of FIG. 12. After extensive optimization and trial-and-error analysis, the design of the present invention was found to be surprisingly effective not only high takeoff angles (i.e., for NVIS) but also at low and medium takeoff angles over a wide range of frequencies to provide a very smooth behavior with no dropouts (e.g., VSWR, gain, or radiation pattern anomalies at some frequencies) that other antennas exhibit; see, e.g., FIGS. 13-17) . Several additional design iterations were then conducted to refine the mechanical design and assembly method of the system 100, to improve the packaging and mechanical aspects of the system as illustrated and described above.

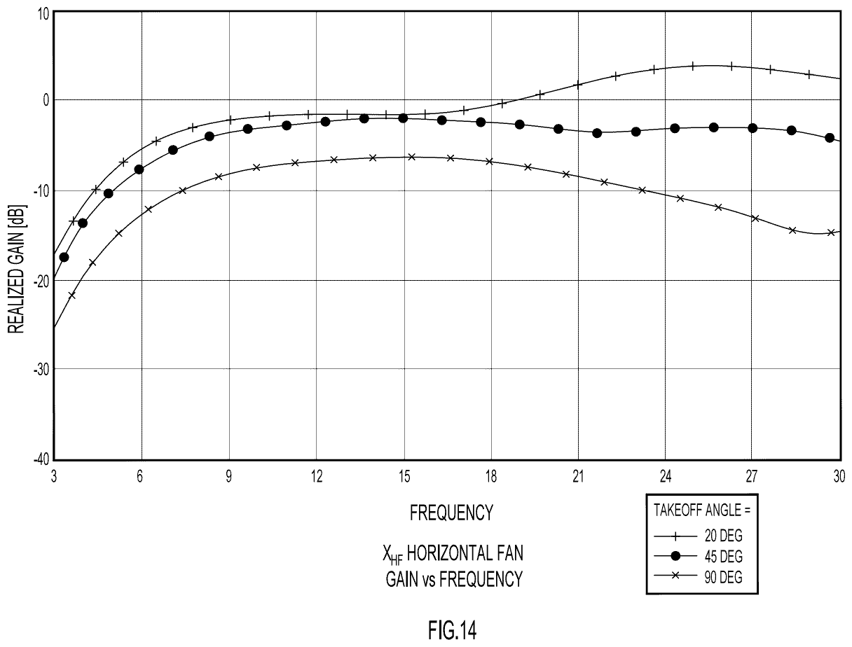

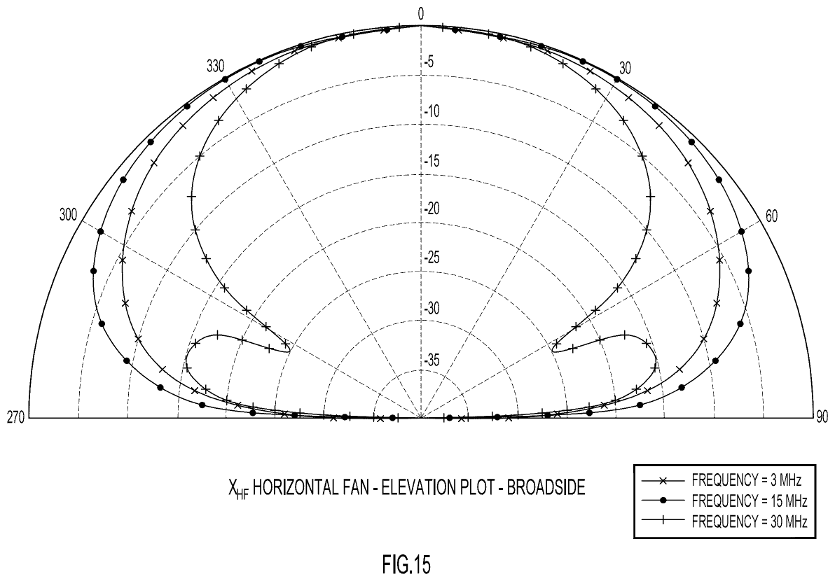

Turning to FIGS. 13-17, the performance of X_{HF} horizontal fan antenna system 100 with dipole fan antenna assembly (e.g., with 5 wire dipole fan assembly 300A) shows why expeditionary users will appreciate these improvements. FIG. 13 is a graphic illustration representing the SWR versus frequency modelled and measured performance over a frequency range of 3 MHz to 30 MHz, while FIG. 14 shows plotted data for horizontal fan gain over those frequencies for three horizontal takeoff angles, namely 20 degrees (e.g., for long skip propagation 6 as illustrated in FIGS. 1A), 45 degrees and straight up at 90 degrees (for NVIS propagation 2) and for all three elevation angles, XHF horizontal fan antenna system 100 provides useful gain and VSWR at just about any frequency and at just about any elevation angle. FIGS. 15, 16 and 17 show azimuth plots (around the compass) shows horizontal fan gain over those frequencies for those three horizontal takeoff angles, illustrating that expeditionary users can quickly set up X_{HF} horizontal fan antenna system 100 with the opposing dipole fans aligned along just about any azimuth and are almost certain to receive useful signals without any undue fiddling, adjustment or aiming the dipole fans.

Surprisingly, the transportable HF dipole antenna system of the present invention 100 provides a VSWR of less than 2 over a frequency range of 8 MHz to 30 MHz while providing a horizontal fan radiation pattern at a horizontal or long skip takeoff angle of 20 degrees that varies (gain) in the range of 0 db to −5 dB for HF frequencies in the range of 3 MHz to 15 MHz, so expeditionary users can set up the XHF antenna system of the present invention quickly and are more likely to immediately receive signals from nearly any azimuth without undue dipole element setup or aiming trial and error. This kind of compactness and ease of use (performance) are significant improvements over what the prior art can provide, as illustrated in the prototype modelling and testing data compiled and illustrated in

The dipole fan antenna assembly (e.g., 300A) may be assembled before deployment or assembled or repaired with pre-configured wire element segments with attached connectors in the field, with instructions provided or transmitted to the user when deployed. The user instructions preferably include diagrams and illustrations such as those shown in FIGS. 2-11G showing Transportable Rapidly Deployable High-Frequency (HF) Horizontal Fan Antenna System 100 set up with first fan antenna assembly (e.g., 300A) and second fan antenna assembly (e.g., 300B) connected to elevated paw assembly and thus connected to Balun connector assembly 400 at the top of mast 200 where each fan assembly's distal or bottom edge or connector for a bottom wire (e.g., at 370) is supported along a horizontal plane at a selected bottom edge height or elevation 510 (e.g., 7.5 feet) above a selected reference plane 500 corresponding to ground level. For purposes of providing definite limiting descriptive language, in the system 100 and method of the present invention, selected bottom edge height or elevation is preferably between 6 and 7.5 feet (with a tolerance of + or − one foot) above ground reference plane 500 or (less preferred) greater than one half meter or 2 feet above the selected reference plane 500. Once assembled, the height of the upper, or distal vertical ends of the wires comprising each fan antenna assembly are electrically connected or bonded to Balun connector assembly 400 at a selected antenna system height or elevation 520 which is less than 10 meters or 30 feet (e.g., 29 feet) above that selected reference plane 500 corresponding to ground level.

The method for site selection and assembly of an embodiment of antenna system 100 as illustrated in FIGS. 2-11G is preferably provided to the user in a format easily reviewed in the field, and may be stored in or transmitted to a portable communication device such as a smart phone, terminal or tablet, optionally configured to work with a dedicated transceiver (not shown). The method and instructions may be stored in memory as part of a computer program stored or transmitted in modules for specific users in specific environments. The user or operator can connect user-selected radio equipment (e.g., 30) to an N-type coaxial cable fitting connected to the antenna 300 during installation. While the type of coaxial cable used is up to the user, an exemplary prototype works well with either Times Microwave LMR-400 or LMR-600 as suitable RF cabling solutions. In use with a receiver, The X_{HF} system 100 can simultaneously receive incoming HF signals over the entire 3-30 MHz HF band without significant variation in performance. When used in transmit operations, the X_{HF} system 100 has demonstrated good performance up to transmit powers of 1500 Watts. However, at frequencies below 7 MHz, an optional 3-dB attenuator (i.e., pad) is preferably inserted in-line between the radio and antenna 300. The attenuator pad must be rated appropriately for the application specific transmit power level. For frequencies of 7-30 MHz, a transmitting radio can be connected directly to the system. A tuner can be used between the radio and the antenna assembly 100 if available or built into radio instead of the pad.

It will be appreciated by persons of skill in that art that the present invention makes available an easily transportable rapidly deployable substantially horizontal High-Frequency (HF) antenna system (e.g. 100), comprising: a Base 110, and a Mast 200 removably attachable to said base, with an dipole fan antenna 300 assembly having first and second conductive fan elements (or first and second fan or triangular element assemblies 300A, 300B) connected to a Balun Matching Transformer and supported at the top of a mast of selected height 400 where each fan element is configured to operate over a bottom edge conductive element at ground (e.g., as illustrated in FIGS. 2-11E). Antenna system 100, when deployed and erected, defines a dual fan shaped horizontal antenna with sloped, planar fan shaped or triangular antenna elements (300A, 300B) which can be employed to project and receive HF signals in a selected radiation pattern having a selected main beam shape (see FIGS. 15-17) and providing a selected gain, main beam or antenna radiation pattern over a selected frequency band. In the illustrated exemplary embodiment, the antenna element configuration 300 illustrated in FIGS. 2, 8 and 9 support the Near Vertical Incident Skywave (“NVIS”) HF communications.

The method for deploying and erecting the substantially horizontal High-Frequency (HF) antenna system (e.g. 100) as described and illustrated includes a number of method steps including (a) providing a Base 120, a Mast 200 configured to be removably attachable to said base, and providing or assembling (on site) an Antenna 300 including first fan antenna assembly 300A and second fan antenna assembly 300B which are configured with a plurality of electrical connectors to be connected to a Balun Matching Transformer 400; (b) erecting said base 120 and said mast 200 and then (c) attaching the structural components and electrically conductive first fan antenna assembly 300A and second fan antenna assembly 300B of said antenna 300 to said mast and configuring said antenna's structural and electrically conductive components to provide a substantially horizontal dual fan shaped array; (d) and connecting said balun matching transformer 400 and fan shaped 330, 360 to said antenna and to an HF radio or transceiver which can be employed to project and/or receive HF signals over a selected frequency band.

In the exemplary embodiment of system 100 illustrated in FIGS. 2-11G, Balun 400 may be configured as Palomar Engineers Model CB-9-1-1500TSN, with the following specifications: Hybrid 9:1 Current Balun, 1.8-61 MHz, 1.5KW PEP, Type N Connector and this was supported upon mast 200, a MK-6-STD, a 32 feet standard duty fiberglass multi-section push up mast.

### X_{HF} Enhanced NVIS Two Wire Antenna System Performance Comparisons

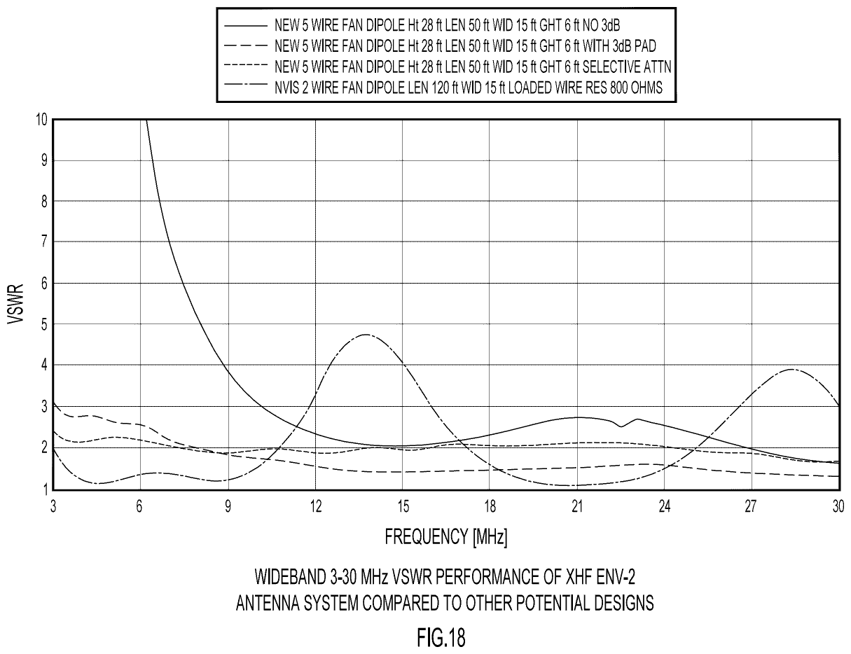

Turning next to FIGS. 18-21 when a user configures an antenna system with the X_{HF} ENV-2 dipole fan antenna assemblies (e.g., 1300A, 1300B, as illustrated in FIGS. 11A-11C, with a user-supplied 40 foot mast) that transportable antenna system was found to achieve two distinct design goals, namely (a) improved low-frequency NVIS HF operations while (b) maintaining good performance for higher HF frequencies to support long-range communications. The X_{HF} ENV-2 equipped antenna system illustrated in perspective in the diagram of FIG. 11A has first and second conductive wire triangular fan shaped elements 1300A, 1300B supported and connected at the top of the mast 1200 to a Balun assembly 1400 via (preferably) first and second spreader paw connector members (e.g., like 410A and 410B) where each fan element (e.g., 1300A, 1300B) comprises only the two outer wire segment assemblies (e.g., 1360, 1362).

The embodiment of antenna system 100, when is equipped with the X_{HF} ENV-2 dipole fan antenna assemblies (e.g., 1300A, 1300B) defines a dual or dipole fan shaped sloped horizontal antenna which can be employed to project and receive HF signals in a selected radiation pattern having a selected main beam shape and providing a selected gain, main beam or antenna radiation pattern over a selected frequency band (see, e.g., FIGS. 18-21) and supports both Long Range (i.e., long skip propagation 6) and Near Vertical Incident Skywave (“NVIS”) HF communications.

FIG. 18 is a graphical representation or data plot illustrating antenna SWR impedance match performance over a wideband HF frequency range of 3 MHz to 30 MHz, comparing four exemplary embodiments of the expeditionary antenna system of the present invention. Wideband 3-30 MHz VSWR Performance for the antenna system 100 in two configurations, namely, (a) five wire configuration similar to that illustrated in FIGS. 2-10 with five wire fan assembly (e.g., 300A), with three excitation modes and (b) a X_{HF} ENV-2 two-wire antenna configuration (e.g., 1300A), comparing two antenna configurations with a variety of excitation/attenuation options.

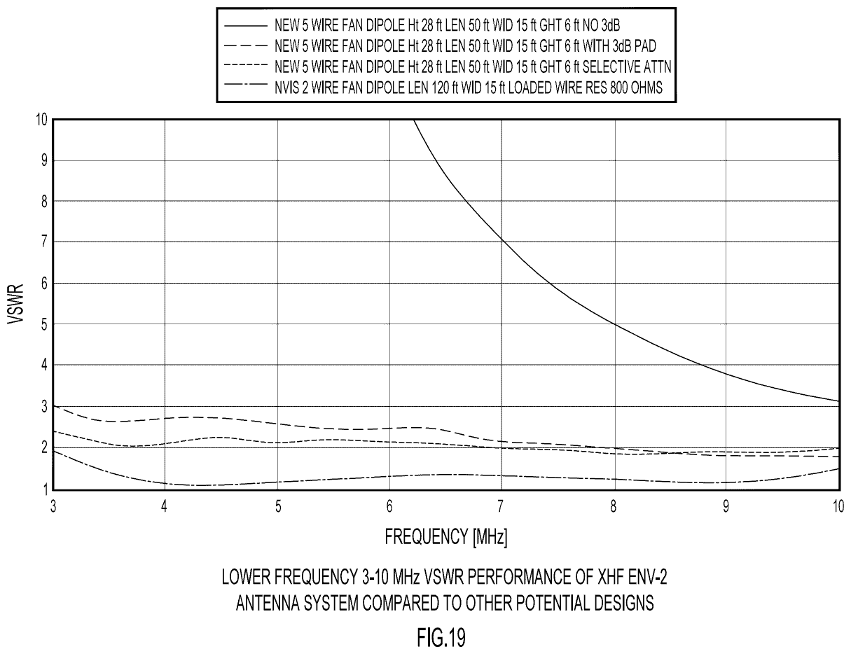

FIG. 19 is a graphical representation or data plot illustrating antenna SWR impedance match performance over a narrower band HF frequency range of 3 MHz to 10 MHz, comparing four exemplary embodiments of the expeditionary antenna system of the present invention, i.e., 3-10 MHz VSWR Performance for the antenna system 100 in two configurations, namely, (a) five wire configuration similar to that illustrated in FIGS. 2-10 with five wire fan assembly (e.g., 300A), with three excitation modes and (b) a X_{HF} ENV-2 two-wire antenna configuration (e.g., 1300A), comparing two antenna configurations with a variety of excitation/attenuation options.

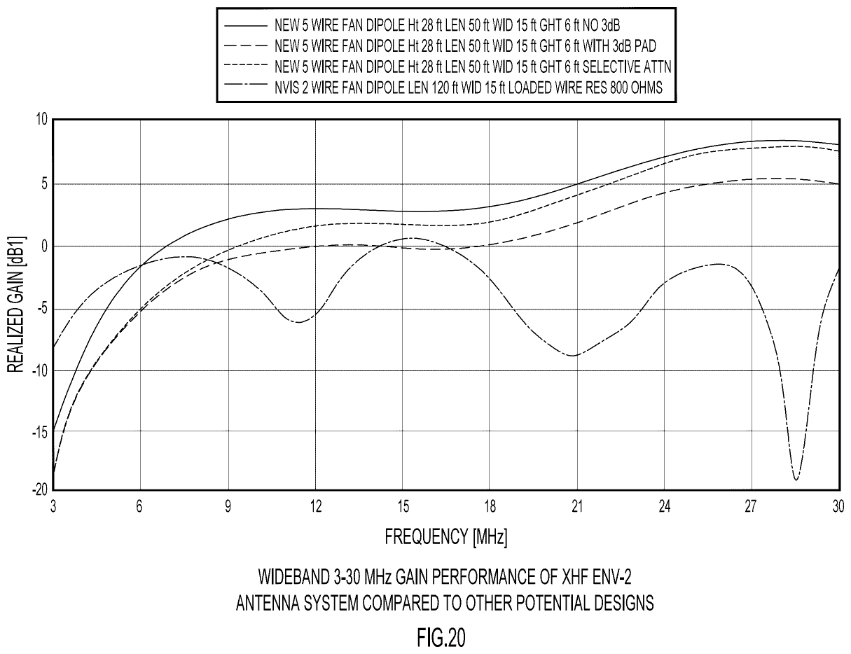

FIG. 20 is a graphical representation or data plot illustrating antenna gain performance over a wideband HF frequency range of 3 MHz to 30 MHz, comparing the same four exemplary embodiments of the expeditionary antenna system of FIGS. 18 and 19, and FIG. 21 is a graphical representation or data plot showing Lower Frequency (3-10MHz, for NVIS) Gain performance of XHF ENV-2 antenna system, compared to the five wire fan antenna assembly 300 of FIGS. 2-9, with the same antenna system configuration and attenuation/excitation options as used to generate the data for FIGS. 18-20.

Persons of skill in the art will appreciate from the foregoing that the eXpeditionary HF (“X_{HF}”) antenna and coupling system 100, once assembled and erected on a site, is significantly smaller than prior art HF antennas that support low-frequency NVIS operation. The enhanced NVIS expeditionary (“ENV-2”) antenna and coupling system and method provides options with advantageous capabilities. All of these embodiments provide much more consistent gain and VSWR performance across the 3-30 MHz HF frequency band compared to other HF antennas, and provide much higher bandwidth than other HF antenna systems. The system 100 does not require any external tuner. The system is far simpler than other HF antennas and can be installed in a much shorter time. The system is much lower cost than comparable HF antennas (comparable in terms of capability). The X_{HF} system is the only known HF system that provides wide bandwidth in a small, simple form factor and is the only known antenna to provide high performance for low frequency HF NVIS operations in a small form factor.

In the context of pre-programmed software for use in a communication system with any of the antenna system embodiments (e.g., X_{HF} 5 wire Horizontal Fan Antenna system 100 with first fan antenna assembly 300A and second fan antenna assembly 300B), the system of the present invention may be configured with a mobile computing or communications device (not shown) including programming to receive, store or display user instructions for assembly or communication operations. The method steps or operations described herein can be programmed as non-transitory program code (e.g., computer-executable instructions, datastores, etc.), which may be stored on one or more tangible, computer-readable storage media that, when executed by one or more processors, perform the recited operations. Generally, computer-executable instructions include routines, programs, objects, components, data structures, and the like that perform particular functions or implement particular abstract data types which may be stored and executed as modules. The order in which the operations are described is not necessarily intended to be construed as a limitation, and any number of the described operations can be combined in any order and/or in parallel to implement the process.

The term “module” refers broadly to locally executed software, software executed in the cloud, hardware, or firmware components (or any combination thereof). Modules are typically functional components that can generate useful data or other output using specified input(s). A module may or may not be self-contained. An application program (also called an “application”) may include one or more modules, or a module may include one or more applications. Generally, modules may include programs, components, objects, routines, logic, data structures, and so on that perform and implement particular tasks. A task may be practiced in distributed cloud computing environments, where tasks are performed by remote processing devices that are linked through a communications network. Modules may be located in a local computer system storage medium/media and/or remote computer system storage medium/media. Modules generally carry out the functions and/or methodologies of embodiments.

Modules may be stored in, for example, memory, operating systems, one or more application programs, other program modules, and program data. The memory may include computer-readable storage media (“CRSM”), which may be any available physical media accessible by the processor to execute instructions stored on the memory. In an implementation, CRSM may include random access memory (“RAM”), flash memory and/or cache memory. In other implementations, CRSM may include, but is not limited to, read-only memory (“ROM”), electrically erasable programmable read-only memory (“EEPROM”), or any other medium which can be used to store the desired information and which can be accessed by the processor.

Computer programs used in an antenna system of the present invention (e.g., X_{HF} 5 wire Horizontal Fan Antenna 100) may be stored in memory, which may be physically present on the system or an external device/system in communication with the system, e.g., so-called “cloud” applications. Computer programs may also be received via a communication interface. Such computer programs, when run, enable the computer system to perform the features of the present embodiments as discussed herein. In particular, the computer programs, when run, enable the processing unit to perform the features of the computer system. Accordingly, such computer programs represent controllers of the computer system. For example, a storage system may be provided for reading from and writing to a non-removable, non-volatile magnetic media (e.g., a hard drive) or other memory. A magnetic disk drive for reading from and writing to a removable, non-volatile magnetic disk (e.g., a disk), and an optical disk drive for reading from or writing to a removable, non-volatile optical disk such as a CD-ROM, DVD-ROM or other optical media can be provided. In such instances, each can be connected to bus by one or more data media interfaces.

Terms “computer program medium,” “computer usable medium,” and “computer-readable medium” are used to generally refer to media such as main memory, including RAM, cache, and storage system, such as a removable storage drive and a hard disk installed in a hard disk drive. Computer-readable storage medium can be a tangible device that can retain and store instructions for use by an instruction execution device. The computer-readable storage medium may be, for example and without limitation, an electronic storage device, a magnetic storage device, an optical storage device, an electromagnetic storage device, a semiconductor storage device, or any suitable combination of the foregoing. A computer-readable storage medium, as used herein, is to be construed as non-transitory, and is not to be construed as being transitory signals per se, whereas the HF (wireless radio analog) signals radiated from and received by the antenna system of the present invention are transitory signals.

While particular embodiments have been shown and described, it will be understood to those skilled in the art that based upon the teachings herein, changes and modifications may be made without departing from its broader aspects. Therefore, the appended claims are to encompass within their scope all such changes and modifications as are within the true spirit and scope of the embodiments. Furthermore, it is to be understood that the embodiments are solely defined by the appended claims. It will be understood by those with skill in the art that if a specific number of an introduced claim element is intended, such intent will be explicitly recited in the claims, and in the absence of such recitation no such limitation is present. For non-limiting example, as an aid to understanding, the following appended claims may contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to the embodiments containing only one such element, even when the same claim includes the introductory phrases “one or more” or “at least one” and indefinite articles such as “a” or “an”; the same holds true for the use in the claims of definite articles. As used herein, the term “and/or”, as in “A, B, and/or C,” means either or multiple or all (or any combination or all the terms or expressed referred to), such as: A; B; C; A and B; A and C; B and C; or A, B, and C.

The corresponding structures, materials, acts, and equivalents of all means or step plus function elements which may be included in the claims below are intended to include any structure, material, or act for performing the function in combination with other claim elements as specifically claimed. The description of the present embodiments has been presented for purposes of illustration and description, but is not intended to be exhaustive or limited to the embodiments in the form disclosed. Many modifications and variations will be apparent to those of ordinary skill in the art without departing from the scope and spirit of the embodiments. The embodiments were chosen and described in order to best explain the principles of the embodiments and the practical application, and to enable others of ordinary skill in the art to understand the embodiments for various embodiments with various modifications and combinations with one another as are suited to the particular use contemplated. Accordingly, the scope of protection of the embodiment(s) is limited only by the following claims and their equivalents.

Having described exemplary and preferred embodiments of new and improved antenna systems and methods, it is believed that other modifications, variations and changes will be suggested to those skilled in the art in view of the teachings set forth herein. It is therefore to be understood that all such variations, modifications and changes are believed to fall within the scope of the present invention. Claims:

1. A Transportable Rapidly Deployable High-Frequency (HF) Horizontal Fan Antenna System (e.g., 100), comprising:
a transportable HF dipole antenna system support system or kit including a multi-section or telescoping central elevated support member or mast configured to provide support for first and second central elevated electrical connections (e.g., 410A, 410B) to and mechanical support for upper connection points for a first fan planar antenna assembly (e.g., 300A) and a second fan antenna assembly (e.g., 300B), each of said fan antenna assemblies comprising first and second outer wire elements (e.g., 360, 362) that is radially arrayed at a selected acute angle (e.g. 330) less than 45 degrees from a second outer edge wire segment to define a planar sloped fan shape. aligned along a downwardly sloped plane and terminating in outer wire element distal ends (e.g., 360B, 362B);
wherein once erected, the first fan antenna assembly (e.g., 300A) and second fan antenna assembly (e.g., 300B) are radially arrayed at substantially 180 degrees from one another (see, e.g., FIGS. 2 and 6) and the selected spread or horizontal distance (e.g., 530) between the opposing bottom edge wire elements is less than 60 feet or 18 meters (e.g., preferably approximately 51 feet, see FIG. 3);
wherein said transportable HF dipole antenna system (e.g., 100) when connected to a HF radio (e.g., 30) provides a VSWR impedance match of less than 2 over a frequency range of 8MHz to 30MHz; and
wherein said transportable HF dipole antenna system (e.g., 100) provides a horizontal fan radiation pattern at a takeoff angle of 20 degrees that varies in the range of 0db to −5 dB for HF frequencies in the range of 3 MHz to 15 MHz.

2. The Transportable Rapidly Deployable High-Frequency (HF) Horizontal Fan Antenna System (e.g., 100) of claim 1, wherein said first fan antenna assembly (e.g., 300A) further includes a central wire element (e.g., 364) connected at a first or upper end to said central elevated electrical connection (e.g., 410A) and said central wire element is aligned between said outer wire elements (e.g., 360, 362) along said sloped plane with a distal lower end (e.g., 364B) terminating in a horizontal ground height plane (e.g., 510) with said first and second outer wire ends (e.g., 360B, 362B).

3. The Transportable Rapidly Deployable High-Frequency (HF) Horizontal Fan Antenna System (e.g., 100) of claim 1, wherein, said when said antenna system is erected, each fan antenna assembly (e.g., 2300A) defines a sloped wire element array comprising a plurality of wire segments terminated at bottom or distal ends edge by a bottom edge wire segment (e.g., 370) that is electrically bonded or connected to a first edge wire segment (e.g., 360) that is radially arrayed at a selected acute angle (e.g.

330) less than 45 degrees from a second outer edge wire segment (e.g., 362) to define a wire mesh fan shape (e.g., 2300A).

4. The Transportable Rapidly Deployable High-Frequency (HF) Horizontal Fan Antenna System (e.g., 100) of claim 1, wherein each of said first fan antenna assembly (e.g., 300A) and second fan antenna assembly (e.g., 300B), when said antenna system is erected, define a sloped planar wire element array comprising a plurality of wire segments terminating distally in bottom or distal ends terminating in said horizontal ground height plane (e.g., 510) with said first and second outer wire ends 360B, 362B spaced apart by a distance (e.g., 370) of greater than 10 feet and less than 30 feet to define a fan shape.

5. The Transportable Rapidly Deployable High-Frequency (HF) Horizontal Fan Antenna System (e.g., 100) of claim 1, wherein each of said first fan antenna assembly 300A and second fan antenna assembly 300B, when said antenna system is erected, define first and second sloped antenna elements aligned in opposing directions such that the first fan antenna assembly bottom edge (e.g., 370A) and the second fan antenna assembly bottom edge (e.g., 370B) are aligned in a substantially co-planar orientation along said horizontal ground plane at selected bottom edge height or elevation greater than one half meter or two feet above a selected ground reference plane 500 corresponding to ground level.

6. The Transportable Rapidly Deployable High-Frequency (HF) Horizontal Fan Antenna System (e.g., 100) of claim 2,
wherein said first fan antenna assembly 300A and second fan antenna assembly 300B define first and second sloped antenna elements aligned in opposing directions such that the first fan antenna assembly bottom edge and the second fan antenna assembly bottom edge are aligned in a substantially co-planar orientation along the horizontal ground height plane at a selected bottom edge height or elevation 510 of between 5 and 8 feet above the selected reference ground plane 500 corresponding to ground level.

7. The Transportable Rapidly Deployable High-Frequency (HF) Horizontal Fan Antenna System (e.g., 100) of claim 2, wherein, once assembled, the first fan antenna assembly (e.g., 300A) and second fan antenna assembly (e.g., 300B) are radially arrayed at substantially 180 degrees from one another (see, e.g., FIGS. 2 and 6) and the selected spread or horizontal distance (e.g., 530) between the opposing bottom edge wire elements is less than 60 feet or 18 meters (see FIG. 3).

8. The Transportable Rapidly Deployable High-Frequency (HF) Horizontal Fan Antenna System (e.g., 100) of claim 2, wherein, once assembled, the first fan antenna assembly 300A and second fan antenna assembly 300B are radially arrayed at substantially 180 degrees from one another (see, e.g., FIGS. 2 and 6) and the selected spread or horizontal distance 530 between the opposing bottom edge wire elements is less than 52 feet (see FIG. 3).

9. The Transportable Rapidly Deployable High-Frequency (HF) Horizontal Fan Antenna System (e.g., 100) of claim 2, wherein, once assembled,
said first fan antenna assembly 300A and said second fan antenna assembly 300B, are radially arrayed at substantially 180 degrees from one another (with a tolerance of + or − 5 degrees, are each stretched tightly to define a sloped wire fan plane to define (as seen in FIGS. 3, 5 and 6) an isosceles triangle that is more than 27 feet tall with a bottom edge that is 51 feet long (with selected tolerances (of, e.g., + or − one foot)). Once erected, first fan antenna assembly 300A has a first fan slope angle (from vertical) 540A which is defined by the isosceles triangle (with a tolerance of + or − 5 degrees) and second fan antenna assembly 300B has a second fan slope angle (from vertical) 540B which is equal in magnitude to a first fan slope angle 540A (with a tolerance of + or − 5 degrees).

10. The Transportable Rapidly Deployable High-Frequency (HF) Horizontal Fan Antenna System (e.g., 100) of claim 2, wherein, each of said first fan antenna assembly 300A and second fan antenna assembly 300B once assembled, comprise a substantially triangular wire fan each assembled from a plurality of connected conductive (preferably metal alloy, e.g., steel, aluminum or copper alloy) wire elements, with at least a first outer wire element 360, a second outer wire element 362, and a central wire element (e.g., 364) with distal ends aligned along an elevated horizontal plane (e.g., 510).

11. The Transportable Rapidly Deployable High-Frequency (HF) Horizontal Fan Antenna System (e.g., 100) of claim 2, wherein, each of said first fan antenna assembly 300A and second fan antenna assembly 300B once assembled, comprise a substantially triangular wire mesh each assembled from a plurality of connected conductive (preferably metal alloy, e.g., steel, aluminum or copper alloy) wire elements, with at least five substantially vertical wire elements (namely first outer wire element 360, second outer wire element 362, central wire element 364, first medial wire element 366 and second medial wire element 368) connected with (preferably color coded) connectors to a plurality of substantially transverse wire elements which are evenly spaced from and arrayed in parallel with said bottom edge element 370.

12. A Transportable Rapidly Deployable High-Frequency (HF) and NVIS Horizontal Fan (ENV-2) Antenna System (e.g., with fan assembly 1300), comprising:
a transportable kit including a balun assembly configured to be connected to a central elevated support member or mast and configured to provide first and second central elevated electrical connections to and mechanical support for upper connection points for a first fan antenna assembly 1300A and a second fan antenna assembly 1300B;
wherein once erected, the first fan antenna assembly 1300A and second fan antenna assembly 1300B are radially arrayed at substantially 180 degrees from one another (with a tolerance of + or − 5 degrees, see, e.g., FIGS. 11A-11C) and the selected spread or horizontal distance 530 between the opposing bottom wire element distal ends is less than 20 feet;
wherein said transportable (ENV-2) Antenna System (e.g., with fan assembly 1300) provides a VSWR impedance match of less than 2 over a frequency range of 3 MHz to 10 MHz; and
wherein said transportable (ENV-2) Antenna System (e.g., with fan assembly 1300) provides a realized gain that varies in the range of −2 dB to −8 dB for HF frequencies in the range of 3 MHz to 10 MHz

13. A method for deploying and erecting a substantially horizontal High-Frequency (HF) antenna system (e.g. 100), comprising:
(a) providing a base (e.g., 120), a telescoping or sectioned central support or mast (e.g., 200) with a mast top end (e.g., 400) said mast being configured to be removably attachable to said base and extended, an antenna assembly (e.g., 300) comprising a first dipole antenna assembly (e.g., 300A) with a plurality of at least two wire elements (e.g., 360, 362) connected at one end to a first conductive spreader paw (e.g., 410A) and a second dipole antenna assembly (e.g., 300B) with a plurality of wire elements connected at one end to a second conductive spreader paw (e.g., 410B), said first and second conductive spreader paws being configured to be releasably attached to an insulated guy point configured to be attached proximate to said mast top 400;
(b) assembling said base 120 and said mast 200 while said mast is not fully extended;
(c) attaching said first dipole antenna assembly (e.g., 300A) first conductive spreader paw (e.g., 410A) to said insulated guy point proximate to said mast top 400 and extending the first dipole antenna assembly wire elements (e.g., 360, 362) into a planar fan shaped configuration along a first sloped plane projecting downwardly at a selected sloped angle (e.g., 540A) from said mast top 400 along a first dipole antenna assembly central axis aligned along a first azimuth (e.g., North);
(d) attaching said second dipole antenna assembly (e.g., 300B) second conductive spreader paw (e.g., 410B) to said insulated guy point proximate to said mast top 400 and extending the second dipole antenna assembly wire elements (e.g., 360, 362) into said planar fan shaped configuration along a second sloped plane projecting downwardly at a selected sloped angle (e.g., 540B) from said mast top 400 along a second dipole antenna assembly central axis which is substantially colinear with said first dipole antenna assembly central axis but 180 away, aligned along an opposing azimuth (e.g., South);
(e) raising or extending the central support or mast (e.g., 200) so that the top end (e.g., 400) projects upwardly from a ground reference plane (e.g., 500) by a selected antenna top end attachment height (e.g., 550), greater than 27 feet (preferably 28 or 29 feet); and
(f) supporting the lower distal coplanar ends (e.g., 360, 362) of said first dipole antenna assembly (e.g., 300A) in an orientation intersecting with a horizontal ground height plane (e.g., 510) at a selected height above (e.g., 6 feet to 7.5 feet) a reference ground plane (e.g., 500).

14. The method for deploying and erecting a substantially horizontal High-Frequency (HF) antenna system of claim 13, wherein, before extending the mast and raising the mast top, configuring said antenna systems and connecting said balun assembly (e.g., 402) to said first and second fan dipole antenna assemblies (e.g., 300A, 300B) and connecting said balun assembly to an HF radio or transceiver (e.g., 30) which can be employed to project or receive HF signals in a selected frequency band (e.g.,3-10 MHz or 3-30 MHz).
